(19) United States
(12) Patent Application Publication
(10) Pub. No.: US 2025/0088024 A1
(43) Pub. Date: Mar. 13, 2025

(54) CHARGING SYSTEMS INCLUDING A MULTI-FUNCTION DC-TO-DC CONVERTER, AND ASSOCIATED METHODS

(71) Applicant: Analog Devices, Inc., Wilmington, MA (US)

(72) Inventors: Ananthakrishnan Viswanathan, San Jose, CA (US); Anthony Kwan Yin Lam, Stevenson Ranch, CA (US)

(21) Appl. No.: 18/800,324

(22) Filed: Aug. 12, 2024

Related U.S. Application Data
(60) Provisional application No. 63/582,214, filed on Sep. 12, 2023.

(51) Int. Cl. H02J 7/34; H02J 7/00

(52) U.S. Cl. CPC H02J 7/34; H02J 7/0063; H02J 7/00712; H02J 2207/20

(57) ABSTRACT

A charging system includes a multi-function direct-current-to-direct-current (DC-to-DC) converter, an energy storage device, and a controller configured to control at least the multi-function DC-to-DC converter to enable the charging system to operate in at least any one of the following operating modes: (a) a first operating mode at least partially characterized by the multi-function DC-to-DC converter charging the energy storage device using energy from an input power source, (b) a second operating mode at least partially characterized by the multi-function DC-to-DC converter powering a first load using energy from the input power source, and (c) a third operating mode at least partially characterized by the multi-function DC-to-DC converter powering a second load using energy from the input power source.

### RELATED APPLICATIONS

This application claims benefit of U.S. Provisional Patent Application No. 63/582,214, filed on Sep. 12, 2023, which is incorporated herein by reference.

### BACKGROUND

Charging systems are used, for example, to charge portable electronic devices, such as hearing aids, wireless earbuds, smart watches, mobile phones, etc. A charging system commonly includes a battery to enable the charging system to charge a device even when the charging system is not connected to an external power source, such as when a user of the charging system is “on the go” (OTG).

### BRIEF DESCRIPTION OF THE DRAWINGS

FIG. 1 is a schematic diagram of an electrical environment including a charging system, where the charging system includes a multi-function direct-current-to-direct-current (DC-to-DC) converter, according to an embodiment.

FIG. 2 is a schematic diagram of an embodiment of the FIG. 1 electrical environment where an energy storage device is embodied by two batteries electrically coupled in series.

FIG. 3 illustrates one example of energy flow in the FIG. 1 charging system in a first operating mode of the charging system.

FIG. 4A illustrates one example of control signals in the FIG. 1 charging system in the first operating mode of the charging system where the multi-function DC-to-DC converter operates as a buck converter.

FIG. 4B illustrates one example of control signals in the FIG. 1 charging system in the first operating mode of the charging system where the multi-function DC-to-DC converter operates as a boost converter.

FIG. 5 illustrates one example of energy flow in the FIG. 1 charging system in a second operating mode of the charging system.

FIG. 6 illustrates one example of control signals in the FIG. 1 charging system in the second operating mode of the charging system.

FIG. 7 illustrates one example of energy flow in the FIG. 1 charging system in a third operating mode of the charging system.

FIG. 8 illustrates one example of control signals in the FIG. 1 charging system in the third operating mode of the charging system.

FIG. 9 illustrates one example of energy flow in the FIG. 1 charging system in a fourth operating mode of the charging system.

FIG. 10 illustrates one example of control signals in the FIG. 1 charging system in the fourth operating mode of the charging system.

FIG. 11 illustrates one example of energy flow in the FIG. 1 charging system in a fifth operating mode of the charging system.

FIG. 12 illustrates one example of control signals in the FIG. 1 charging system in the fifth operating mode of the charging system.

FIG. 13 is a flow chart of a method for operating the FIG. 1 charging system where the charging system operates in the first, second, and third operating modes for equal durations of time.

FIG. 14 is a flow chart of a method for operating the FIG. 1 charging system where the charging system operates in the second operating mode for a disproportionate amount of time.

FIG. 15 is a flow chart of a method for operating the FIG. 1 charging system where the charging system operates in the fourth and fifth operating modes for equal durations of time.

FIG. 16 is a flow chart of another method for operating the FIG. 1 charging system where the charging system operates in the first, second, and third operating modes for equal durations of time.

FIG. 17 is a flow chart of a method for operating the FIG. 1 charging system where the charging system operates in the first operating mode for a disproportionate amount of time.

FIG. 18 is a flow chart of a method for operating the FIG. 1 charging system where the charging system operates in its fifth operating mode for a disproportionate amount of time.

FIG. 19 is a schematic diagram of an electrical environment including an alternate embodiment of the FIG. 1 charging system.

FIG. 20 illustrates one example of control signals in the FIG. 19 charging system in a second operating mode of the charging system.

FIG. 21 illustrates one example of control signals in the FIG. 19 charging system in a fourth operating mode of the charging system.

FIG. 22 is a schematic diagram of an alternate embodiment of the FIG. 1 electrical environment where a first input power source is replaced with a load.

FIG. 23 illustrates one example of energy flow in the FIG. 22 charging system in a sixth operating mode of the charging system.

FIG. 24 illustrates one example of control signals in the FIG. 22 charging system in the sixth operating mode of the charging system where the multi-function DC-to-DC converter operates as a buck converter.

FIG. 25 illustrates one example of control signals in the FIG. 22 charging system in the sixth operating mode of the charging system where the multi-function DC-to-DC converter operates as a boost converter.

FIG. 26 is a schematic diagram of an alternate embodiment of the FIG. 1 electrical environment further including a third input power source.

FIG. 27 is a schematic diagram of an alternate embodiment of the FIG. 1 electrical environment further including a third load.

FIG. 28 is a schematic diagram of an alternate embodiment of the FIG. 1 electrical environment further including a second energy storage device.

FIG. 29 is a schematic diagram of an electrical environment including a charging cradle, where the charging cradle includes an embodiment of the charging system of FIG. 1.

### DETAILED DESCRIPTION OF THE EMBODIMENTS

Conventional charging systems include two or more inductors, as well as a large quantity of switching devices, as part of their power conversion circuitry. Inductors are relatively large and costly, which contributes to charging system size and cost. Additionally, while switching devices may be smaller than inductors, switching devices also contribute to charging system size and cost. Furthermore, the power conversion circuitry of conventional charging systems forms two or more direct-current-to-direct-current (DC-to-DC) converters which may simultaneously operate and thereby impair charging system efficiency, as each operating DC-to-DC converter will contribute to charging system power loss.

Disclosed herein are charging systems and associated methods which may at least partially overcome the above discussed drawbacks of conventional charging systems. The new charging systems include a multi-function DC-to-DC converter that is capable of charging an energy storage device, as well powering a plurality of loads at different voltage magnitudes, with use of only a single inductor, thereby promoting small charging system size, low charging system cost, and efficient charging system operation. Additionally, particular embodiments of the new charging system require fewer switching devices than conventional charging systems of similar functionality, which further helps achieve small power conversion circuitry size and cost, as well as high charging system efficiency. Moreover, the new multi-function DC-to-DC converters could be used applications other than charging system applications.

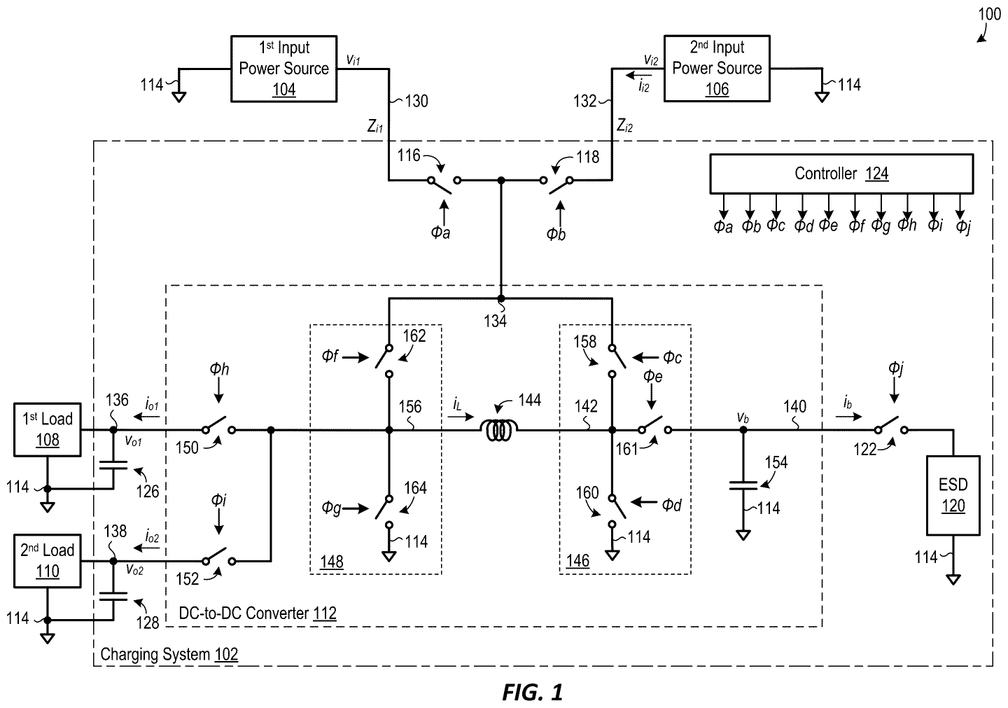

FIG. 1 is a schematic diagram of an electrical environment 100 including a charging system 102, a first input power source 104, a second input power source 106, a first load 108, and a second load 110. Charging system 102 is one embodiment of the new charging systems disclosed herein, and as discussed below, charging system 102 includes a DC-to-DC converter 112 which is one embodiment of the new multi-function DC-to-DC converters disclosed herein. In certain embodiments, first input power source 104 includes an Universal Serial Bus (USB) power source, and second input power source 106 includes a wireless charging power source, such as a wireless charging power source configured to receive energy via an externally generated magnetic field. However, the configuration of first input power source 104 and second input power source 106 may vary as a design choice. Additionally, it should be noted that first input power source 104 and/or second input power source 106 are not necessarily always present in electrical environment 100, and first input power source 104 and second input power source 106 therefore may be unavailable for use by charging system 102 from time to time. For example, certain embodiments of charging system 102 are portable, and a user of charging system 102 may move charging system 102 away from first input power source 104 and second input power source 106, such as when the user of charging system 102 is “on the go” (OTG).

Each of first load 108 and second load 110 includes, for example, one or more portable electronic devices, such as a hearing aid, a wireless earbud, a smart watch, a mobile phone, etc. First input power source 104, second input power source 106, first load 108, and second load 110 are depicted as being electrically referenced to a reference node 114, which is denoted by a downward pointing triangle. In some embodiments, reference node 114 is a ground node, such as an earth ground node or a chassis ground node. In other embodiments, reference node 114 is floating with respect to a ground node, or stated differently, reference node 114 may be at a different electrical potential than earth ground or another ground node.

As discussed further below, charging system 102 is configured to power first load 108 and second load 110, e.g., for charging one or more batteries (not shown) of each of the loads, from energy received from either first input power source 104 or second input power source 106. Additionally, charging system 102 is configured to power first load 108 and second load 110 from energy stored in charging system 102 when first input power source 104 and second input power source 106 are unavailable, such as when a user of charging system 102 is OTG and charging system 102 is therefore away from first input power source 104 and second input power source 106. Additionally, charging system 102 is capable of powering each of first load 108 and second load 110 such that these two loads are at different respective voltages vₒ₁ and vₒ₂.

Charging system 102 includes DC-to-DC converter 112, a first input switching device 116, a second input switching device 118, an energy storage device 120, a battery switching device 122, a controller 124, a first output capacitor 126, and a second output capacitor 128. In this document, a “switching device” is device that is capable of operating in at least an open state and a closed state in response to a control signal. Accordingly, a switching device can selectively electrically couple two or more nodes and/or two or more devices, in response to a control signal. In particular, a switching device electrically couples two or more nodes and/or two or more devices by closing in response to a control signal commanding the switching device to close, and a switching device electrically decouples two or more nodes and/or two or more devices by opening in response to a control signal commanding the switching device to open. In some embodiments, each switching device disclosed herein includes one or more transistors, such as one or more field effect transistors (FETs), one or more bipolar junction transistors (BJTs), one or more insulated gate bipolar junction transistors (IGBTs), etc. For example, a switching device that need not be capable of preventing reverse current flow may include a single FET, while a switching device that must be capable of preventing reverse current flow may include an N-channel FET electrically coupled in series with a P-channel FET to prevent undesired FET body diode current conduction.

First input power source 104 is electrically coupled to a first input power node 130, and first input power source 104 drives first input power node 130 to an input voltage vil. First input switching device 116 is electrically coupled between first input power node 130 and an intermediate power node 134, and first input switching device 116 is accordingly configured to selectively electrically couple intermediate power node 134 to first input power source 104 in response to a control signal ϕa generated by controller 124. Similarly, second input power source 106 is electrically coupled to a second input power node 132, and second input power source 106 is configured to drive second input power node 132 to an input voltage vᵢ₂. Second input switching device 118 is electrically coupled between second input power node 132 and intermediate power node 134, and second input switching device 118 is accordingly configured to selectively electrically couple intermediate power node 134 to second input power source 106 in response to a control signal ϕb generated by controller 124.

First load 108 is electrically coupled to a first output power node 136, and first output capacitor 126 is electrically coupled between first output power node 136 and reference node 114. Second load 110 is electrically coupled to a second output power node 138, and second output capacitor 128 is electrically coupled between second output power node 138 and reference node 114. First output capacitor 126 may be omitted in embodiments where first load 108 includes sufficient capacitance so that first output capacitor 126 is not needed. Similarly, second output capacitor 128 may be omitted in embodiments where second load 110 includes sufficient capacitance so that second output capacitor 128 is not needed.

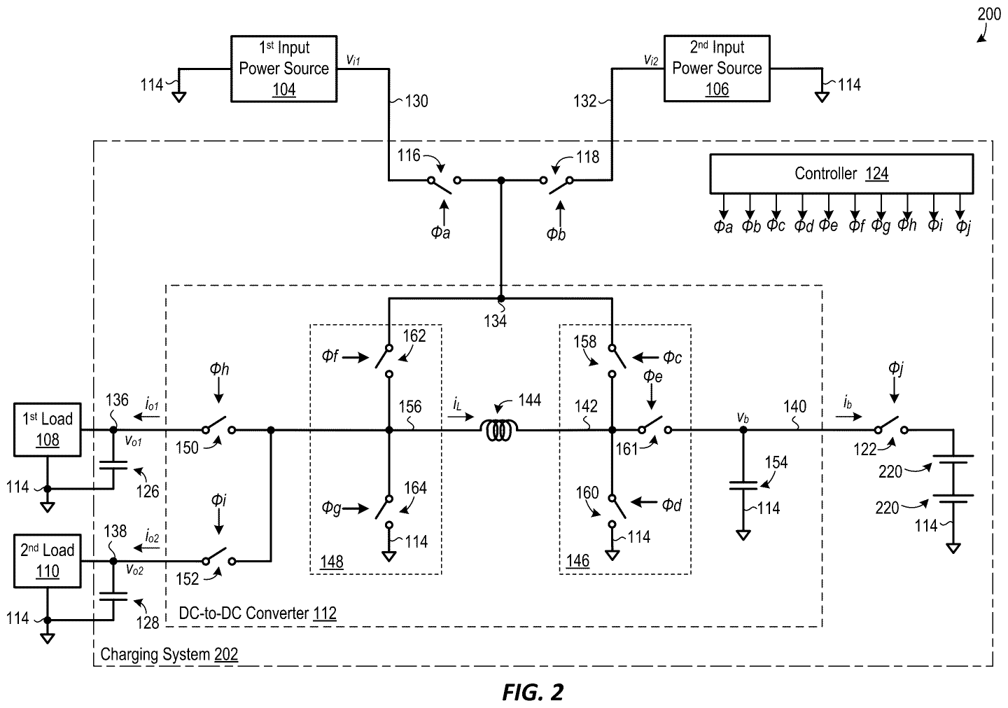

DC-to-DC converter 112 is electrically coupled to each of intermediate power node 134, a battery node 140, first output power node 136, and second output power node 138. Energy storage device 120 is electrically coupled to battery node 140 via battery switching device 122. Accordingly, energy storage device 120 is electrically coupled to battery node 140 and to DC-to-DC converter 112 via battery switching device 122. Battery switching device 122 is configured to selectively electrically couple energy storage device 120 to battery node 140 in response to a control signal ϕj generated by controller 124. In some embodiments, controller 124 is configured to cause energy storage device 120 to be disconnected from battery node 140 in response to an abnormal condition, such as in response to an overload, overcurrent, and/or overtemperature condition of energy storage device 120. Energy storage device 120 includes, for example, one more elements capable of storing energy, such as one or more batteries, one or more capacitors, etc. For example, FIG. 2 is a schematic diagram of an electrical environment 200, which is an embodiment of electrical environment 100 including charging system 102 embodied as a charging system 202. Energy storage device 120 is embodied in charging system 202 by two batteries 220 electrically coupled in series. It is understood, though, that charging system 202 could be modified to include only a single battery 220, or three or more batteries 220 electrically coupled in series without departing from the scope hereof. Additionally, in embodiments of charging system 202 including a plurality of batteries 220, the batteries could be electrically coupled in parallel, or electrically coupled in a parallel-series combination, instead of being electrically coupled in series.

Referring again to FIG. 1, DC-to-DC converter 112 includes an inductor 144, first power conversion switching devices 146, second power conversion switching devices 148, a first load switching device 150, a second load switching device 152, and a capacitor 154. Inductor 144 is electrically coupled between a first switching node 142 and a second switching node 156. First power conversion switching devices 146 include a first upper switching device 158, a first lower switching device 160, and a first intermediate switching device 161, which are each electrically coupled to first switching node 142. Specifically, first upper switching device 158 is electrically coupled between intermediate power node 134 and first switching node 142, first lower switching device 160 is electrically coupled between first switching node 142 and reference node 114, and first intermediate switching device 161 is electrically coupled between first switching node 142 and battery node 140. Second power conversion switching devices 148 include a second upper switching device 162 and a second lower switching device 164, which are each electrically coupled to second switching node 156. Specifically, second upper switching device 162 is electrically coupled between intermediate power node 134 and second switching node 156, and second lower switching device 164 is electrically coupled between second switching node 156 and reference node 114. The quantity and topology of switching devices within first power conversion switching devices 146, as well as the quantity and topology of switching devices within second power conversion switching devices 148, may vary according to required functionality of DC-to-DC converter 112.

First upper switching device 158 is configured to selectively electrically couple first switching node 142 to intermediate power node 134 in response to a control signal ϕc generated by controller 124, and first lower switching device 160 is configured to selectable electrically couple first switching node 142 to reference node 114 in response to a control signal ϕd generated by controller 124. Additionally, first intermediate switching device 161 is configured to electrically couple first switching node 142 to battery node 140 in response to a control signal ϕe generated by controller 124. Second upper switching device 162 is configured to selectively electrically couple second switching node 156 to intermediate power node 134 is response to a control signal ϕf generated by controller 124, and second lower switching device 164 is configured to selectively electrically couple second switching node 156 to reference node 114 in response to a control signal ϕg generated by controller 124.

First load switching device 150 is electrically coupled between second switching node 156 and first output power node 136, and first load switching device 150 is configured to selectively electrically couple first load 108 to second switching node 156 in response to a control signal ϕh generated by controller 124. Second load switching device 152 is electrically coupled between second switching node 156 and second output power node 138, and second load switching device 152 is configured to selectively electrically couple second load 110 to second switching node 156 in response to a control signal ϕi generated by controller 124.

Controller 124 is configured to generate control signals ϕa, ϕb, ϕc, ϕd, ϕe, ϕf, ϕg, ϕh, ϕi, and ϕj to control operation of charging system 102. Controller 124 is formed, for example, of analog and/or digital electronic circuitry. While controller 124 is illustrated as being external to DC-to-DC converter 112, controller 124 could alternately be partially or fully integrated with DC-to-DC converter 112. Additionally, controller 124 could alternately be fully or partially external to charging system 102. Furthermore, although controller 124 is depicted as being a single element, controller 124 could include multiple sub-elements that need not be at a common location. Moreover, controller 124 could be configured to communicate with one or more of first load 108 and second load 110, e.g., as using power line communication or another communication technique, such as to enable controller 124 to control operation of charging system 102 in response to requirements of one or more of first load 108 and second load 110. Additionally, certain embodiments of controller 124 are capable of determining status, e.g., availability, of one or more or more of first input power source 104 and second input power source 106.

Controller 124 is configured to control operation of charging system 102 such that charging system 102 may operate in any one of at least at a first operating mode, a second operating mode, a third operating mode, a fourth operating mode, and a fifth operating mode, discussed below. In particular embodiments, a topology of DC-to-DC converter 112 varies among operating modes, and controller 124 changes operation of first power conversion switching devices 146, second power conversion switching devices 148, first load switching device 150 and/or second load switching device 152 to change the topology of DC-to-DC converter 112 according to operating mode of charging system 102. Additionally, controller 124 may cause charging system 102 to repeatedly change operating modes, such as to enable DC-to-DC converter 112 to perform multiple functions, e.g., to power each of first load 108 and second load 110, as well as charge to charge energy storage device 120, as discussed below.

### First Operating Mode

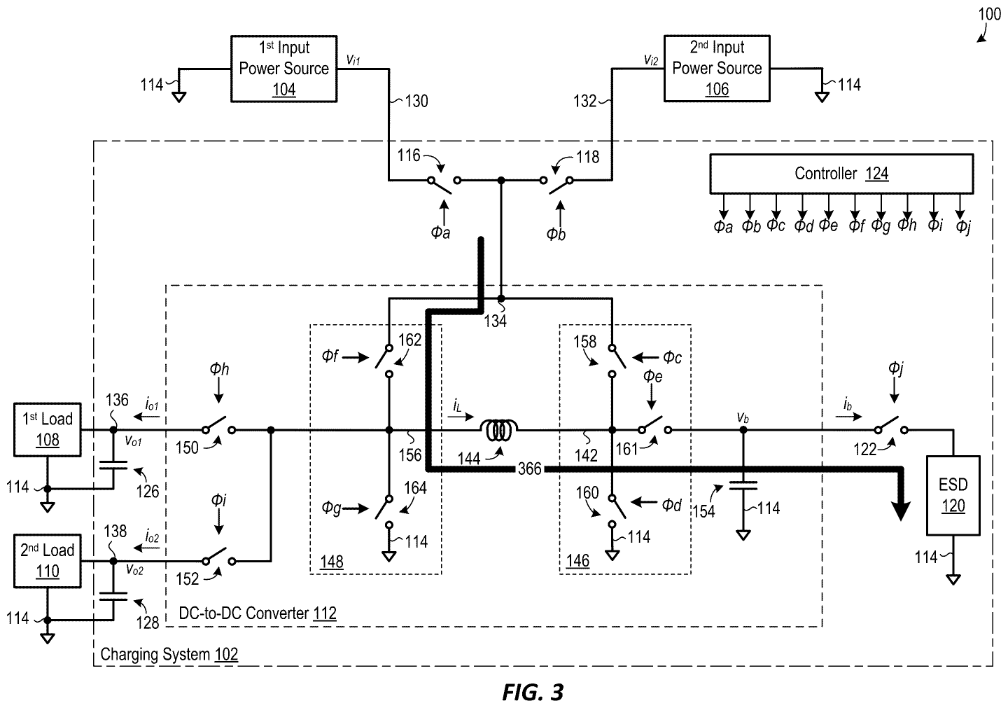

The first operating mode of charging system 102 is characterized by controller 124 controlling each of first input switching device 116, second input switching device 118, DC-to-DC converter 112, and battery switching device 122 such that charging system 102 charges energy storage device 120 using energy from either first input power source 104 or second input power source 106. FIG. 3 is a schematic diagram of electrical environment 100 illustrating one example of operation of charging system 102 in its first operating mode. FIG. 3 includes heavy lines 366 symbolically showing that DC-to-DC converter 112 transfers energy from one of first input power source 104 and second input power source 106 to charge energy storage device 120. Energy flows through inductor 144 from left to right, i.e., from second switching node 156 to first switching node 142, in the first operating mode.

Referring again to FIG. 1, controller 124 selects one of first input power source 104 and second input power source 106 to provide energy to charging system 102, such as for charging energy storage device 120, for example, based on availability of the input power sources and/or a predetermined selection scheme. For example, in particular embodiments, controller 124 is configured to (a) select first input power source 104 for providing energy to charging system 102 whenever first input power source 104 is available and (b) select second input power source 106 for providing energy to charging system 102 whenever first input power source 104 is unavailable. Controller 124 selects first input power source 104 for providing energy to charging system 102 by (a) generating control signal ϕa to cause first input switching device 116 to be closed such that first input power source 104 is electrically coupled to DC-to-DC converter 112 and (b) generating control signal ϕb to cause second input switching device 118 to be open such that second input power source 106 is isolated from DC-to-DC converter 112. On the other hand, controller 124 selects second input power source 106 for providing energy to charging system 102 by (a) generating control signal ϕa to cause first input switching device 116 to be open such that first input power source 104 is isolated from DC-to-DC converter 112 and (b) generating control signal ϕb to cause second input switching device 118 to be closed such that second input power source 106 is electrically coupled to DC-to-DC converter 112.

Controller 124 generates control signals ϕh and ϕi such that first load switching device 150 and second load switching device 152 are open in the first operating mode, such that each of first load 108 and second load 110 is isolated from DC-to-DC converter 112. Controller 124 also generates control signal ϕj such that battery switching device 122 is closed in the first operating mode, thereby enabling energy storage device 120 to be charged via DC-to-DC converter 112. Additionally, controller 124 generates control signals ϕc, ϕd, ϕe, ϕf, and ϕg such that DC-to-DC converter 112 operates as either a buck converter of a boost converter in the first operating mode.

Specifically, controller 124 causes DC-to-DC converter 112 to act as a buck converter in the first operating mode by (a) generating control signals ϕc and ϕd such that first upper switching device 158 and first lower switching device 160 are open, (b) generating control signal ϕe such that first intermediate switching device 161 is closed, (c) generating control signal ϕf, such as using a pulse width modulation (PWM) or pulse frequency modulation (PFM) technique, to control duty cycle of second upper switching device 162 to regulate one or more of magnitude of voltage v_{b} at energy storage device 120 and/or magnitude of current i_{b} flowing through energy storage device 120, and (d) generating control signal ϕg such that second lower switching device 164 performs a freewheeling function, i.e., it provides a path for current i_{L} flowing through inductor 144 when second upper switching device 162 is open.

In contrast, controller 124 causes DC-to-DC converter 112 to act as a boost converter in the first operating mode by (a) generating control signals ϕc and ϕg such that first upper switching device 158 and second lower switching device 164 are open, (b) generating control signal ϕf such that second upper switching device 162 is closed, (c) generating control signal ϕd, such as using a PWM or PFM technique, to control duty cycle of first lower switching device 160 to regulate one or more of magnitude of voltage v_{b} at energy storage device 120 and/or magnitude of current i_{b} flowing through energy storage device 120, and (d) generating control signal ϕe such that first intermediate switching device 161 performs a freewheeling function, i.e., it provides a path for current i_{L} flowing through inductor 144 when first lower switching device 160 is open.

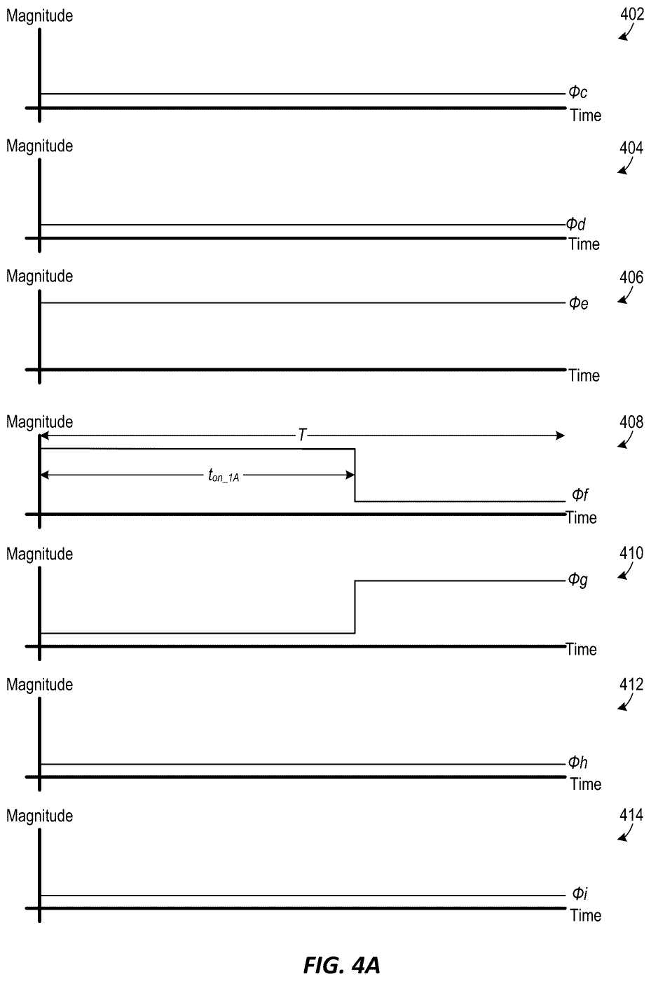

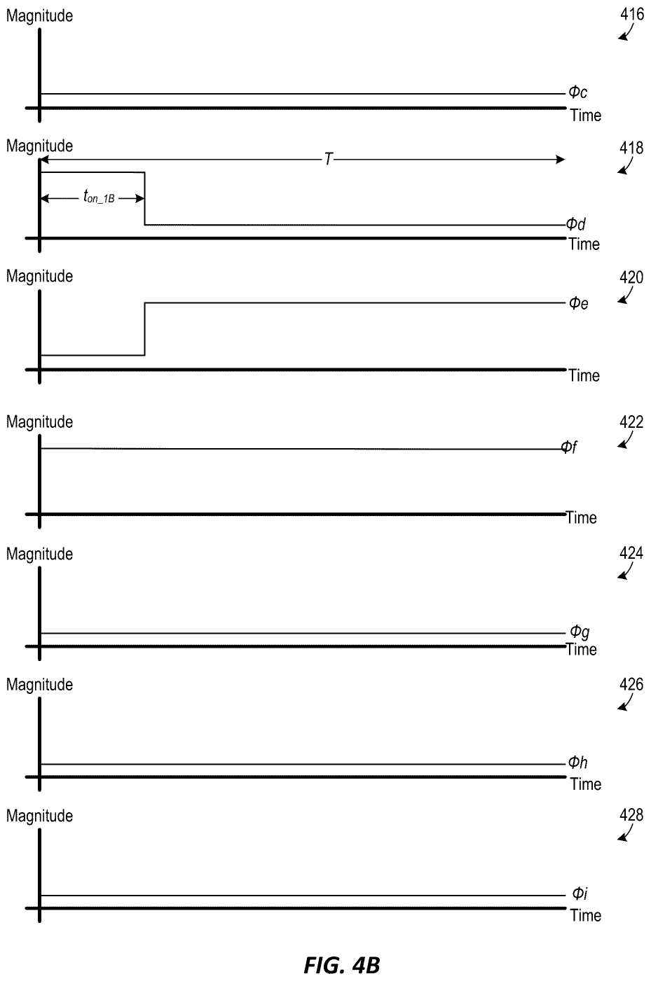

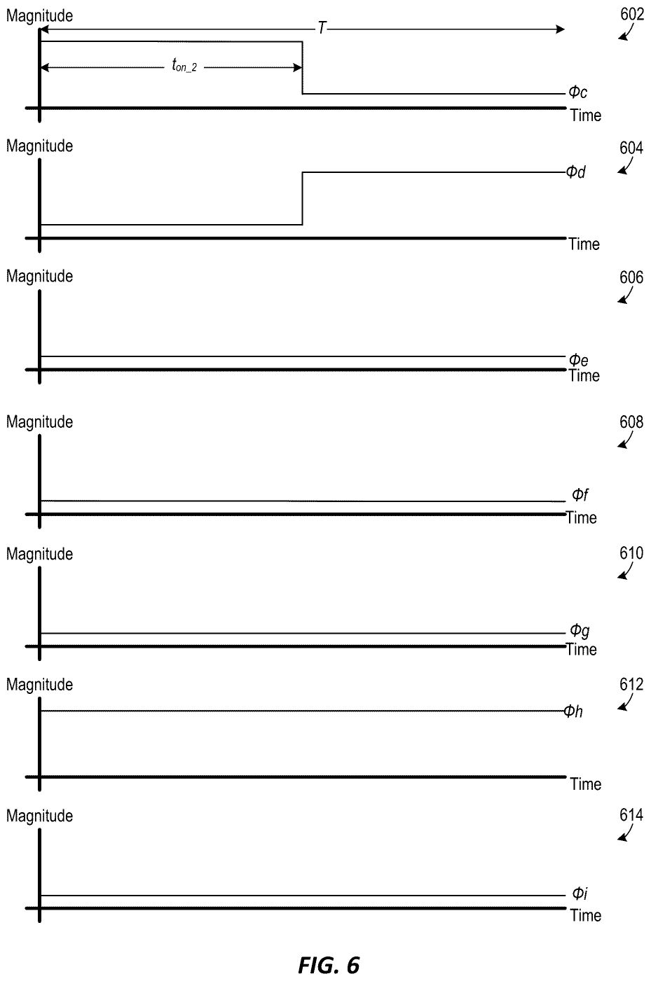

FIGS. 4A and 4B collective illustrate two examples of how charging system 102 may operate in its first operating mode. In particular, FIG. 4A includes seven graphs 402, 404, 406, 408, 410, 412, and 414 respectively illustrating one example of how controller 124 may generate control signals ϕc, ϕd, ϕe, ϕf, ϕg, ϕh, and ϕi during a single switching cycle of DC-to-DC converter 112 in the first operating mode of charging system 102 where DC-to-DC converter 112 operates as a buck converter. Each of graphs 402, 404, 406, 408, 410, 412, and 414 is of signal magnitude versus time, and each of graphs 402, 404, 406, 408, 410, 412, and 414 shares a common time base. The graphs of FIGS. 4A and 4B, as well as the graphs of FIGS. 6, 8, 10, 12, 20, 21, 24, and 25 (discussed below), assume that each switching device is (a) closed when its respective control signal is in a logic high state and (b) open when its respective control signal is in a logic low state. For example, first upper switching device 158 is closed when control signal ϕc is in its logic high state, and first upper switching device 158 is open when control signal ϕc is in its logic low state, in the examples of the graphs herein. However, the control signals of charging system 102 may have different polarities, and switching devices of charging system 102 may respond to control signals in different manners, without departing from the scope hereof.

In the example of FIG. 4A, control signals ϕc, ϕd, ϕh, and ϕi are continuously logic low, and first upper switching device 158, first lower switching device 160, first load switching device 150, and second load switching device 152 therefore continuously operate in their respective open states. Additionally, control signal ϕe is continuously logic high, and first intermediate switching device 161 therefore continuously operates in its closed state. Control signal ϕf switches between logic high and logic low states with a duty cycle of t_{on_1A}/T. Additionally, control signal ϕg is complementary to control signal ϕf, such that DC-to-DC converter 112 operates in a continuous current conduction mode.

FIG. 4B, on the other hand, includes seven graphs 416, 418, 420, 422, 424, 426, and 428 respectively illustrating one example of how controller 124 may generate control signals ϕc, ϕd, ϕe, ϕf, ϕg, ϕh, and ϕi during a single switching cycle of DC-to-DC converter 112 in the first operating mode of charging system 102 where DC-to-DC converter 112 operates as a boost converter. Each of graphs 416, 418, 420, 422, 424, 426, and 428 is of signal magnitude versus time, and each of graphs 416, 418, 420, 422, 424, 426, and 428 shares a common time base. In the example of FIG. 4B, control signals ϕc, ϕg, ϕh, and ϕi are continuously logic low, and first upper switching device 158, second lower switching device 164, first load switching device 150, and second load switching device 152 therefore continuously operate in their respective open states. Additionally, control signal ϕf is continuously logic high, and second upper switching device 162 therefore continuously operates in its closed state. Control signal ϕd switches between logic high and logic low states with a duty cycle of t_{on_1B}/T. Additionally, control signal ϕe is complementary to control signal ϕd, such that DC-to-DC converter 112 operates in a continuous current conduction mode.

It is understood that FIGS. 4A and 4B are not meant to constrain DC-to-DC converter 112 to any particular duty cycle or to any particular mode of operation. For example, DC-to-DC converter 112 may instead operate in a discontinuous current conduction mode. Actual operation of DC-to-DC converter 112 is, for example, implementation dependent and/or operating environment dependent.

### Second Operating Mode

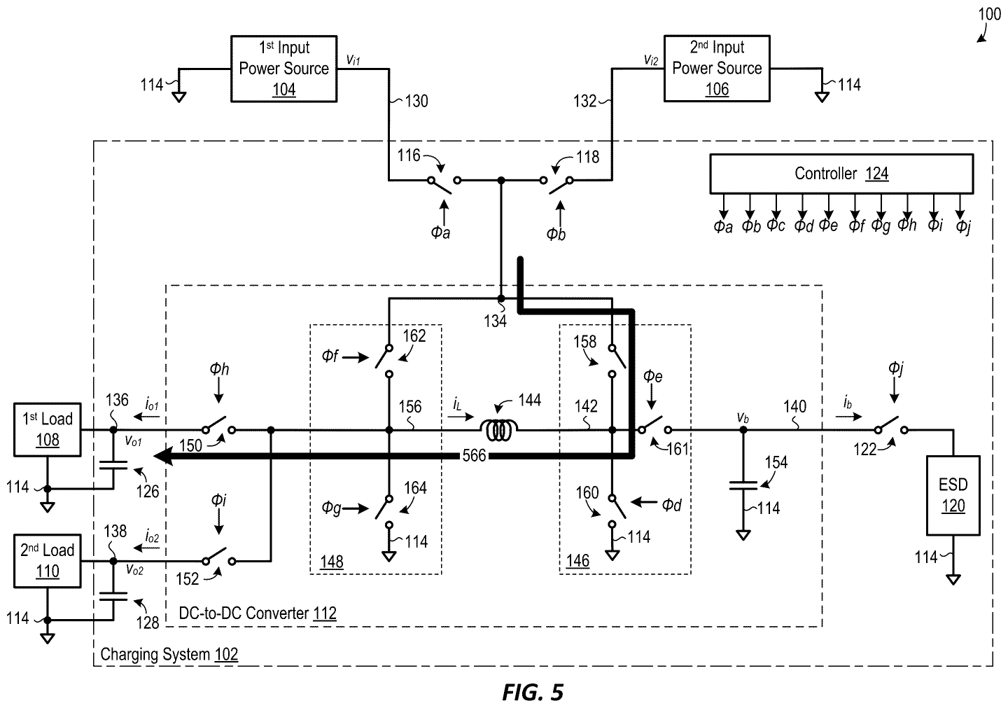

The second operating mode of charging system 102 is characterized by controller 124 controlling each of first input switching device 116, second input switching device 118, DC-to-DC converter 112, and battery switching device 122 such that charging system 102 powers first load 108 using energy from either first input power source 104 or second input power source 106. Controller 124 selects one of first input power source 104 and second input power source 106 to provide energy for powering first load 108, for example, in a manner similar to how controller 124 selects one of first input power source 104 and second input power source 106 in the first operating mode. FIG. 5 is a schematic diagram of electrical environment 100 illustrating one example of operation of charging system 102 in its second operating mode. FIG. 5 includes heavy lines 566 symbolically showing that DC-to-DC converter 112 transfers energy from one of first input power source 104 and second input power source 106 to first load 108. Energy flows through inductor 144 from right to left, i.e., from first switching node 142 to second switching node 156, in the second operating mode. As such, a DC component of current i_{L} flowing through inductor 144 will be negative. Reference character ϕc, shown in FIG. 1, is omitted from FIG. 5 for illustrative clarity.

Referring again to FIG. 1, controller 124 generates control signals ϕe, ϕf, and ϕg such that first intermediate switching device 161, second upper switching device 162, and second lower switching device 164 are open in the second operating mode, such that second power conversion switching devices 148 do not affect operation of DC-to-DC converter 112. Controller 124 additionally generates control signal ϕh such that first load switching device 150 is closed, as well as generates control signal ϕi such that second load switching device 152 is open, in the second operating mode. Accordingly, first load 108 is electrically coupled to DC-to-DC converter 112, and second load 110 is isolated from DC-to-DC converter 112, in the second operating mode.

Controller 124 further generates controls signals ϕc and ϕd such that DC-to-DC converter 112 operates as a buck converter in the second operating mode of charging system 102. In particular, controller 124 generates control signal ϕc, such as using a PWM or PFM technique, to control duty cycle of first upper switching device 158 to regulate one or more of magnitude of voltage vₒ₁ at first load 108 and/or magnitude of current iₒ₁ flowing through first load 108. It should be noted that controller 124 regulates magnitude of voltage vₒ₁ and/or current iₒ₁ in the second operating mode independent of either magnitude of a voltage vₒ₂ at second load 110 or magnitude of a current iₒ₂ flowing through second load 110, due to second load 110 being isolated from DC-to-DC converter 112 in the second operating mode. Controller 124 generates control signal ϕd such that first lower switching device 160 performs a freewheeling function, i.e., it provides a path for current i_{L} flowing through inductor 144 when first upper switching device 158 is open.

FIG. 6 includes seven graphs 602, 604, 606, 608, 610, 612, and 614 respectively illustrating one example of how controller 124 may generate control signals ϕc, ϕd, ϕe, ϕf, ϕg, ϕh, and ϕi during a single switching cycle of DC-to-DC converter 112 in the second operating mode of charging system 102. Each of graphs 602, 604, 606, 608, 610, 612, and 614 is of signal magnitude versus time, and each of graphs 602, 604, 606, 608, 610, 612, and 614 shares a common time base. In the example of FIG. 6, control signals ϕe, ϕf, ϕg, and ϕi are continuously logic low, and first intermediate switching device 161, second upper switching device 162, second lower switching device 164, and second load switching device 152 therefore continuously operate in their respective open states. Control signal ϕh, in contrast, is continuously logic high, and first load switching device 150 therefore continuously operates in its closed state. Control signal ϕc switches between logic high and logic low states with a duty cycle of t_{on_2}/T. Additionally, control signal ϕd is complementary to control signal ϕc, such that DC-to-DC converter 112 operates in a continuous current conduction mode. It is understood, though, that FIG. 6 is not meant to constrain DC-to-DC converter 112 to any particular duty cycle or to any particular mode of operation. For example, DC-to-DC converter 112 may instead operate in a discontinuous current conduction mode. Actual operation of DC-to-DC converter 112 is, for example, implementation dependent and/or operating environment dependent.

### Third Operating Mode

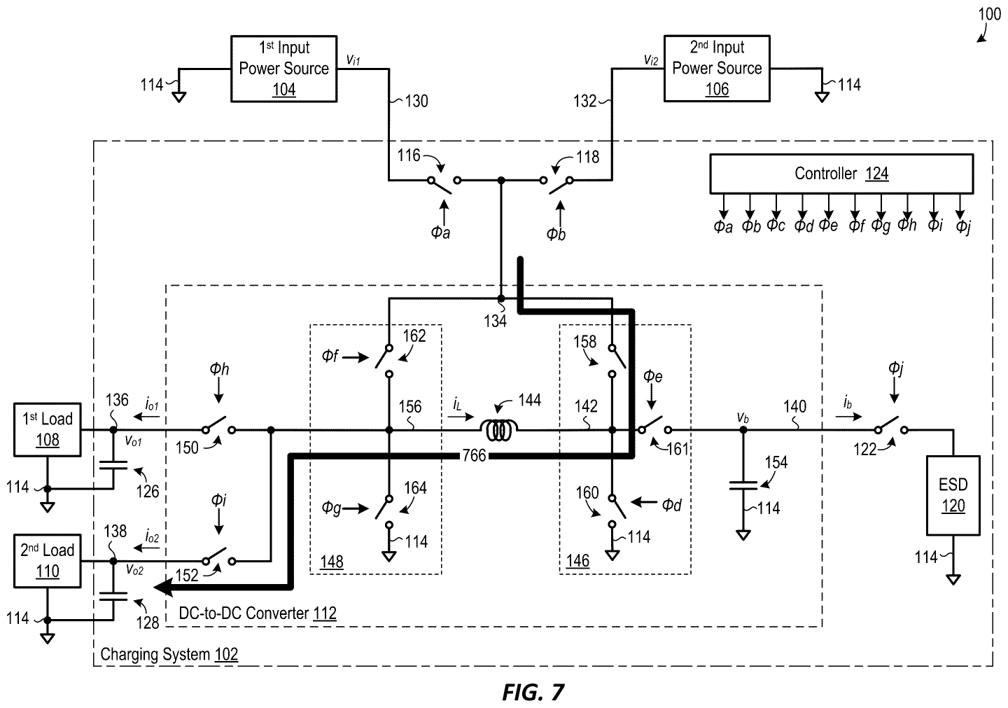

The third operating mode of charging system 102 is characterized by controller 124 controlling each of first input switching device 116, second input switching device 118, DC-to-DC converter 112, and battery switching device 122 such that charging system 102 powers second load 110 using energy from either first input power source 104 or second input power source 106. Controller 124 selects one of first input power source 104 and second input power source 106 to provide energy for powering second load 110, for example, in a manner similar to how controller 124 selects one of first input power source 104 and second input power source 106 in the first operating mode. FIG. 7 is a schematic diagram of electrical environment 100 illustrating one example of operation of charging system 102 in its third operating mode. FIG. 7 includes heavy lines 766 symbolically showing that DC-to-DC converter 112 transfers energy from one of first input power source 104 and second input power source 106 to second load 110. Energy flows through inductor 144 from right to left, i.e., from first switching node 142 to second switching node 156, in the third operating mode. As such, a DC component of current i_{L} flowing through inductor 144 will be negative. Reference character ϕc, shown in FIG. 1, is omitted from FIG. 7 for illustrative clarity.

Referring again to FIG. 1, controller 124 generates control signals ϕe, ϕf, and ϕg such that first intermediate switching device 161, second upper switching device 162, and second lower switching device 164 are open in the third operating mode, such that second power conversion switching devices 148 do not affect operation of DC-to-DC converter 112. Controller 124 additionally generates control signal ϕi such that second load switching device 152 is closed, as well as generates control signal ϕh such that first load switching device 150 is open, in the second operating mode. Accordingly, second load 110 is electrically coupled to DC-to-DC converter 112, and first load 108 is isolated from DC-to-DC converter 112, in the third operating mode.

Controller 124 further generates controls signals ϕc and ϕd such that DC-to-DC converter 112 operates as a buck converter in the third operating mode of charging system 102. In particular, controller 124 generates control signal ϕc, such as using a PWM or PFM technique, to control duty cycle to regulate one or more of magnitude of voltage vₒ₂ at second load 110 and/or magnitude of current iₒ₂ flowing through second load 110. It should be noted that controller 124 regulates magnitude of vₒ₂ and/or iₒ₂ in the third operating mode independent of either magnitude of a voltage vₒ₁ at first load 108 or magnitude of a current iₒ₁ flowing through first load 108, due to first load 108 being isolated from DC-to-DC converter 112 in the third operating mode. Controller 124 generates control signal ϕd such that first lower switching device 160 performs a freewheeling function, i.e., it provides a path for current i_{L} flowing through inductor 144 when first upper switching device 158 is open.

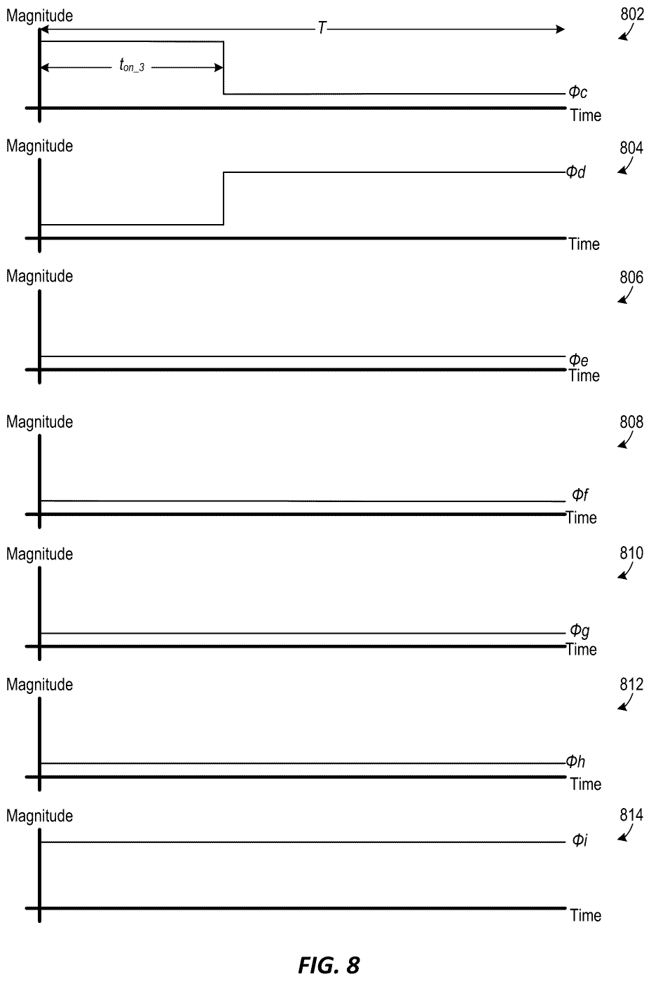

FIG. 8 includes seven graphs 802, 804, 806, 808, 810, 812, and 814 respectively illustrating one example of how controller 124 may generate control signals ϕc, ϕd, ϕe, ϕf, ϕg, ϕh, and ϕi during a single switching cycle of DC-to-DC converter 112 in the third operating mode of charging system 102. Each of graphs 802, 804, 806, 808, 810, 812, and 814 is of signal magnitude versus time, and each of graphs 802, 804, 806, 808, 810, 812, and 814 shares a common time base. In the example of FIG. 8, control signals ϕe, ϕf, ϕg, and ϕh are continuously logic low, and first intermediate switching device 161, second upper switching device 162, second lower switching device 164, and first load switching device 150 therefore continuously operate in their respective open states. Control signal ϕi, in contrast, is continuously logic high, and second load switching device 152 therefore continuously operates in its closed state. Control signal ϕc switches between logic high and logic low states with a duty cycle of t_{on_3}/T. Additionally, control signal ϕd is complementary to control signal ϕc, such that DC-to-DC converter 112 operates in a continuous current conduction mode. It is understood, though, that FIG. 8 is not meant to constrain DC-to-DC converter 112 to any particular duty cycle or to any particular mode of operation. For example, DC-to-DC converter 112 may instead operate in a discontinuous current conduction mode. Actual operation of DC-to-DC converter 112 is, for example, implementation dependent and/or operating environment dependent.

### Fourth Operating Mode

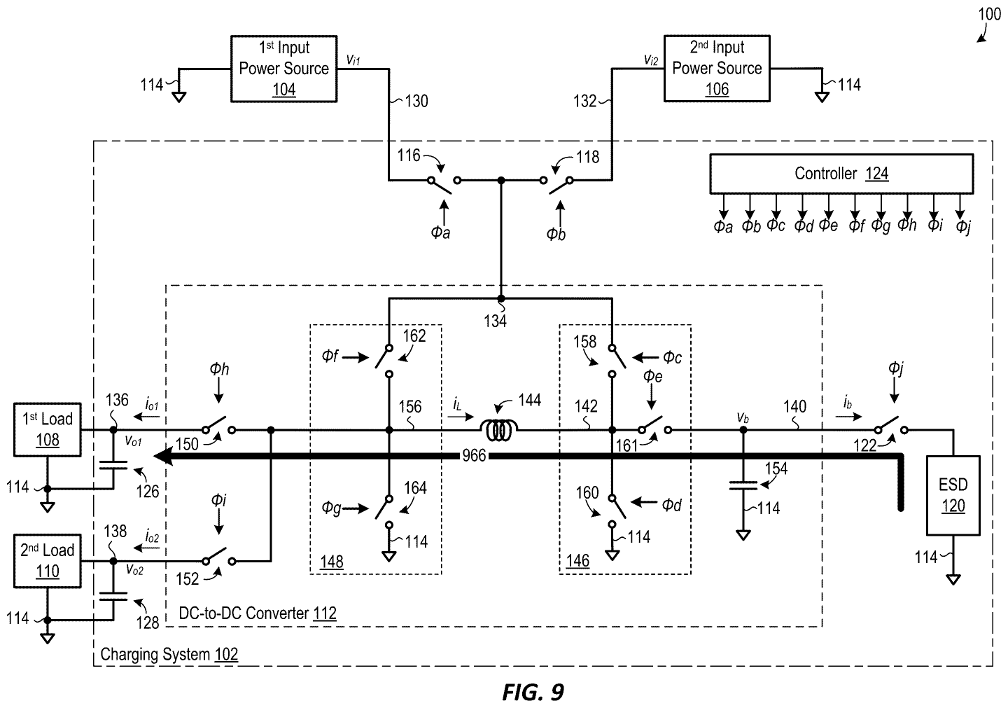

The fourth operating mode of charging system 102 is characterized by controller 124 controlling each of first input switching device 116, second input switching device 118, DC-to-DC converter 112, and battery switching device 122 such that charging system 102 powers first load 108 using energy from energy storage device 120. Charging system 102 operates in its fourth operating mode, for example, when first load 108 needs to be powered and each of first input power source 104 and second input power source 106 is unavailable, such as if a user of charging system 102 is OTG. FIG. 9 is a schematic diagram of electrical environment 100 illustrating one example of operation of charging system 102 in its fourth operating mode. FIG. 9 includes heavy lines 966 symbolically showing that DC-to-DC converter 112 transfers energy from energy storage device 120 to first load 108. Energy flows through inductor 144 from right to left, i.e., from first switching node 142 to second switching node 156, in the fourth operating mode. As such, a DC component of current i_{L} flowing through inductor 144 will be negative.

Referring again to FIG. 1, controller 124 generates control signals ϕc, ϕf, and ϕg such that first upper switching device 158, second upper switching device 162, and second lower switching device 164 are open in the fourth operating mode, such that second power conversion switching devices 148 do not affect operation of DC-to-DC converter 112. Controller 124 additionally generates control signal ϕh such that first load switching device 150 is closed, as well as generates control signal ϕi such that second load switching device 152 is open, in the fourth operating mode. Accordingly, first load 108 is electrically coupled to DC-to-DC converter 112, and second load 110 is isolated from DC-to-DC converter 112, in the fourth operating mode.

Controller 124 further generates controls signals ϕe and ϕd such that DC-to-DC converter 112 operates as a buck converter in the fourth operating mode of charging system 102. In particular, controller 124 generates control signal ϕe, such as using a PWM or PFM technique, to control duty cycle of first intermediate switching device 161 to regulate one or more of magnitude of voltage vₒ₁ at first load 108 and/or magnitude of current iₒ₁ flowing through first load 108. It should be noted that controller 124 regulates magnitude of voltage vₒ₁ and/or current ion in the fourth operating mode independent of either magnitude of a voltage vₒ₂ at second load iₒ₁ or magnitude of a current iₒ₂ flowing through second load 110, due to second load 110 being isolated from DC-to-DC converter 112 in the fourth operating mode. Controller 124 generates control signal ϕd such that first lower switching device 160 performs a freewheeling function, i.e., it provides a path for current i_{L} flowing through inductor 144 when first upper switching device 158 is open.

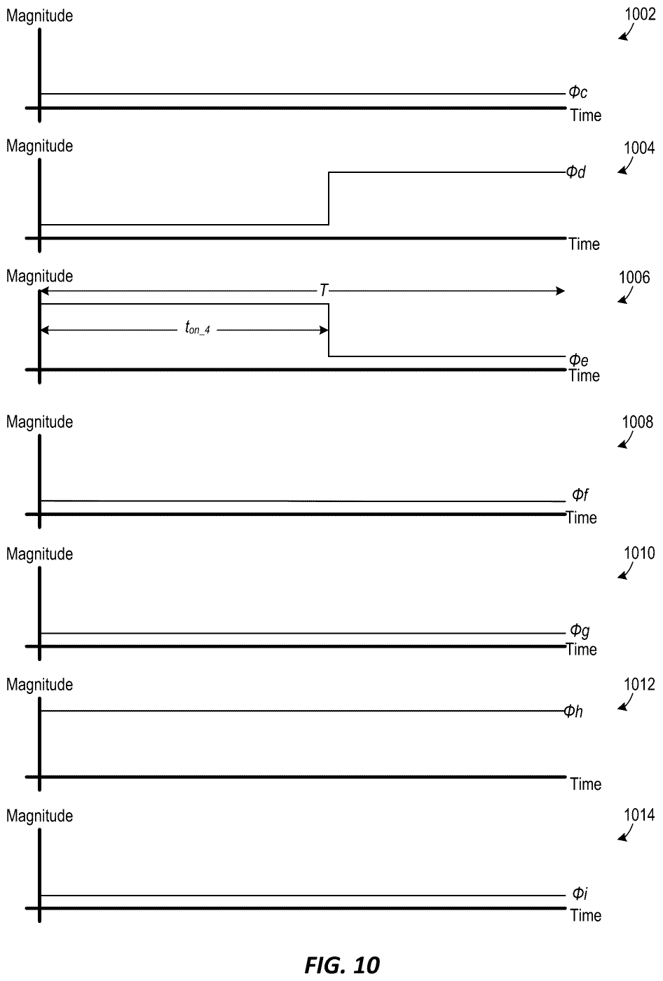

FIG. 10 includes seven graphs 1002, 1004, 1006, 1008, 1010, 1012, and 1014 respectively illustrating one example of how controller 124 may generate control signals ϕc, ϕd, ϕe, ϕf, ϕg, ϕh, and ϕi during a single switching cycle of DC-to-DC converter 112 in the fourth operating mode of charging system 102. Each of graphs 1002, 1004, 1006, 1008, 1010, 1012, and 1014 is of signal magnitude versus time, and each of graphs 1002, 1004, 1006, 1008, 1010, 1012, and 1014 shares a common time base. In the example of FIG. 10, control signals ϕc, ϕf, ϕg, and ϕi are continuously logic low, and first upper switching device 158, second upper switching device 162, second lower switching device 164, and second load switching device 152 therefore continuously operate in their respective open states. Control signal ϕh, in contrast, is continuously logic high, and first load switching device 150 therefore continuously operates in its closed state. Control signal ϕe switches between logic high and logic low states with a duty cycle of t_{on_4}/T. Additionally, control signal ϕd is complementary to control signal ϕe, such that DC-to-DC converter 112 operates in a continuous current conduction mode. It is understood, though, that FIG. 10 is not meant to constrain DC-to-DC converter 112 to any particular duty cycle or to any particular mode of operation. For example, DC-to-DC converter 112 may instead operate in a discontinuous current conduction mode. Actual operation of DC-to-DC converter 112 is, for example, implementation dependent and/or operating environment dependent.

### Fifth Operating Mode

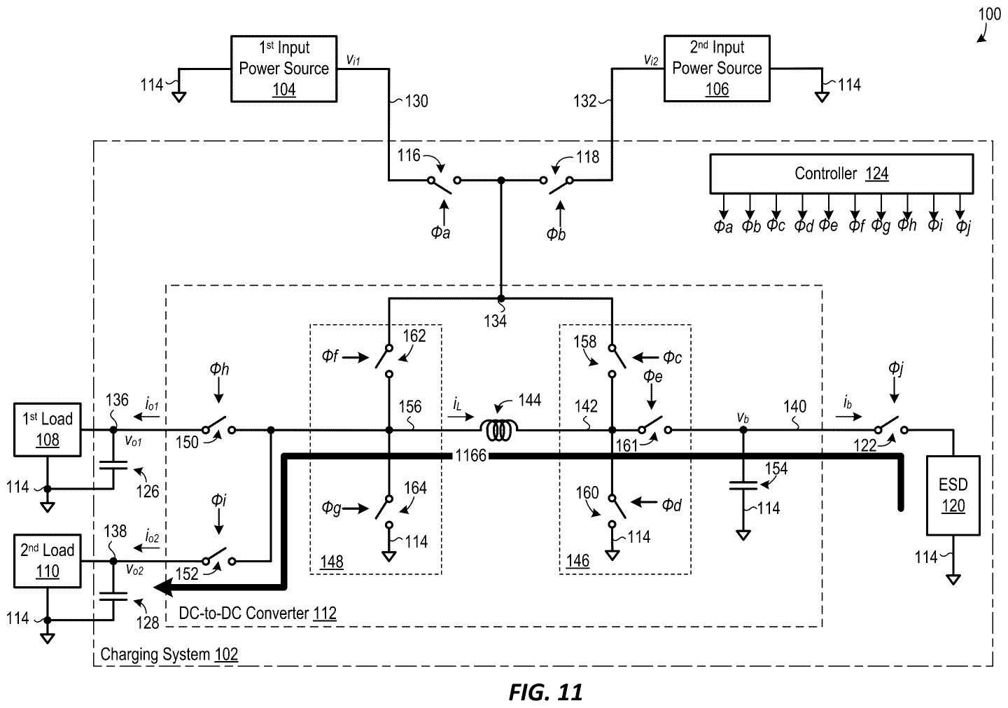

The fifth operating mode of charging system 102 is characterized by controller 124 controlling each of first input switching device 116, second input switching device 118, DC-to-DC converter 112, and battery switching device 122 such that charging system 102 powers second load 110 using energy from energy storage device 120. Charging system 102 operates in its fifth operating mode, for example, when second load 110 needs to be powered and each of first input power source 104 and second input power source 106 is unavailable, such as if a user of charging system 102 is OTG. FIG. 11 is a schematic diagram of electrical environment 100 illustrating one example of operation of charging system 102 in its fifth operating mode. FIG. 11 includes heavy lines 1166 symbolically showing that DC-to-DC converter 112 transfers energy from energy storage device 120 to second load 110. Energy flows through inductor 144 from right to left, i.e., from first switching node 142 to second switching node 156, in the fifth operating mode. As such, a DC component of current i_{L} flowing through inductor 144 will be negative.

Referring again to FIG. 1, controller 124 generates control signals ϕc, ϕf, and ϕg such that first upper switching device 158, second upper switching device 162, and second lower switching device 164 are open in the fifth operating mode, such that second power conversion switching devices 148 do not affect operation of DC-to-DC converter 112. Controller 124 additionally generates control signal ϕi such that second load switching device 152 is closed, as well as generates control signal ϕh such that first load switching device 150 is open, in the fifth operating mode. Accordingly, second load 110 is electrically coupled to DC-to-DC converter 112, and first load 108 is isolated from DC-to-DC converter 112, in the fifth operating mode.

Controller 124 further generates controls signals ϕe and ϕd such that DC-to-DC converter 112 operates as a buck converter in the fifth operating mode of charging system 102. In particular, controller 124 generates control signal ϕe, such as using a PWM or PFM technique, to control duty cycle of first intermediate switching device 161 to regulate one or more of magnitude of voltage vₒ₂ at second load 110 and/or magnitude of current iₒ₂ flowing through second load 110. It should be noted that controller 124 regulates magnitude of voltage vₒ₂ and/or current iₒ₂ in the fifth operating mode independent of either magnitude of a voltage vₒ₁ at first load 108 or magnitude of a current iₒ₁ flowing through first load 108, due to first load 108 being isolated from DC-to-DC converter 112 in the fifth operating mode. Controller 124 generates control signal ϕd such that first lower switching device 160 performs a freewheeling function, i.e., it provides a path for current i_{L} flowing through inductor 144 when first upper switching device 158 is open.

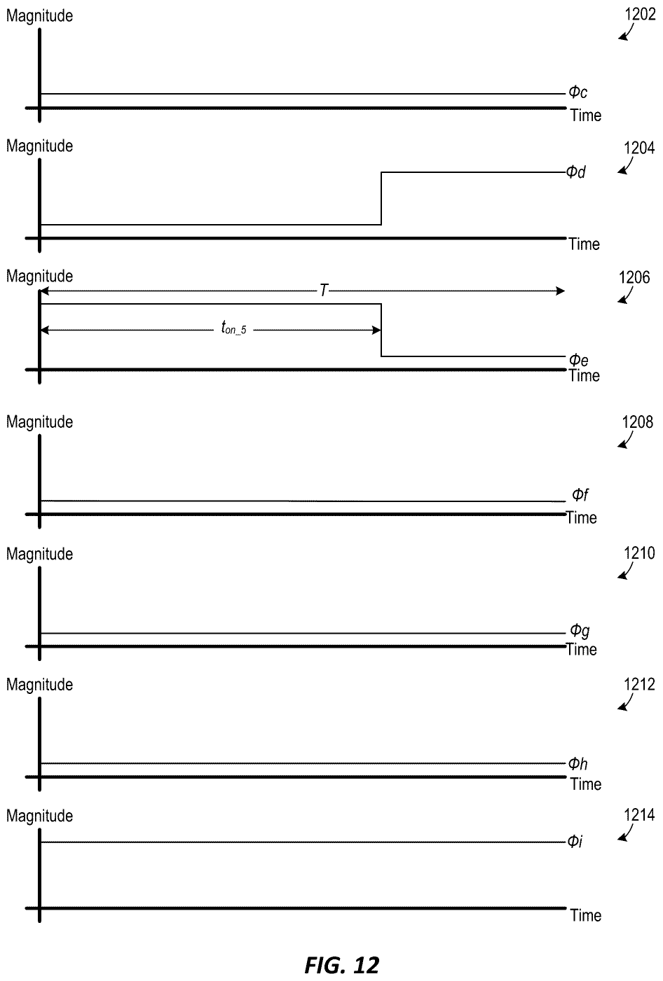

FIG. 12 includes seven graphs 1202, 1204, 1206, 1208, 1210, 1212, and 1214 respectively illustrating one example of how controller 124 may generate control signals ϕc, ϕd, ϕe, ϕf, ϕg, ϕh, and ϕi during a single switching cycle of DC-to-DC converter 112 in the fifth operating mode of charging system 102. Each of graphs 1202, 1204, 1206, 1208, 1210, 1212, and 1214 is of signal magnitude versus time, and each of graphs 1202, 1204, 1206, 1208, 1210, 1212, and 1214 shares a common time base. In the example of FIG. 12, control signals ϕc, ϕf, ϕg, and ϕh are continuously logic low, and first upper switching device 158, second upper switching device 162, second lower switching device 164, and first load switching device 150 therefore continuously operate in their respective open states. Control signal ϕi, in contrast, is continuously logic high, and second load switching device 152 therefore continuously operates in its closed state. Control signal ϕe switches between logic high and logic low states with a duty cycle of t_{on_5}/T. Additionally, control signal ϕd is complementary to control signal ϕe, such that DC-to-DC converter 112 operates in a continuous current conduction mode. It is understood, though, that FIG. 12 is not meant to constrain DC-to-DC converter 112 to any particular duty cycle or to any particular mode of operation. For example, DC-to-DC converter 112 may instead operate in a discontinuous current conduction mode. Actual operation of DC-to-DC converter 112 is, for example, implementation dependent and/or operating environment dependent.

### Switching Operating Modes

As discussed above, each operating mode of charging system 102 is associated with a particular function. In particular, the first operating mode is associated with charging energy storage device 120, the second operating is associated with powering first load 108 from an input power source, the third operating mode is associated with powering second load 110 from an input power source, etc. Particular embodiments of controller 124 are configured to cause charging system 102 repeatedly switch operating modes, such as to periodically switch operating modes, to enable charging system 102 to perform multiple functions, where each function is performed at a different time. It should be noted that although charging system 102 only performs one function at a time, it may appear that charging system 102 is performing multiple functions simultaneously if charging system 102 switches between operating modes at a sufficiently high rate. For example, first output capacitor 126 may support first load 108 during times when charging system 102 is not operating in the second operating mode or the fourth operating mode, such that it appears from the standpoint of first load 108 that charging system 102 is continuously operating in the second or fourth operating mode. As another example, charging system 102 may switch between operating modes at a sufficiently high rate so that an amount of time between successive instances of operating in the first operating mode is small, such that it appears from a macro level that energy storage device 120 is being continuously charged.

Controller 124 may cause charging system 102 to operate in a given operating mode for one or more switching cycles of DC-to-DC converter 112 before switching to a different operating mode. Additionally, controller 124 may change an amount of time that charging system 102 operates in a given operating mode, such as in response to a change in the operating environment of charging system 102. For example, controller 124 may increase an amount of time that charging system 102 operates in the third operating mode before switching to a different operating mode in response to an increase in magnitude of current iₒ₂ flowing through second load 110. Furthermore, controller 124 could be configured so that charging system 102 operates in two or more operating modes for different durations. For example, assume that magnitude of current iₒ₁ flowing through first load 108 is greater than magnitude of current iₒ₂ flowing through second load 110. Controller 124 may cause charging system 102 to operate its fourth operating mode for a longer duration than controller 124 causes charging system 102 to operate in its fifth operating mode, to compensate for magnitude of current iₒ₁ being larger than magnitude of current iₒ₂.

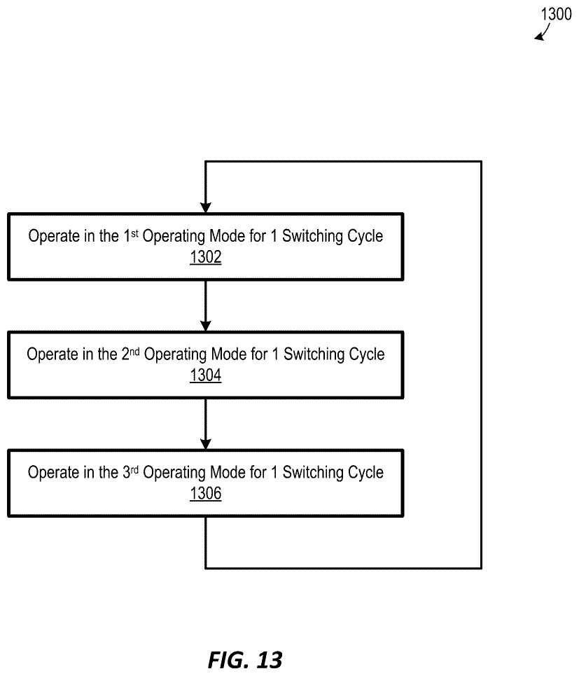

Discussed below with respect to FIGS. 13-18 are several examples of how controller 124 could be configured to cause charging system 102 to repeatedly change operating modes and thereby perform multiple functions. It is understood, though, that controller 124 could be configured to cause charging system 102 to repeatedly change operating modes in other manners without departing from the scope hereof. Additionally, while the methods of FIGS. 13-18 assume that DC-to-DC converter 112 operates at a constant switching frequency such that each switching period of DC-to-DC converter 112 has an equal duration, any of the methods of FIGS. 13-18 could be adapted to embodiments where DC-to-DC converter 112 operates at a variable switching frequency.

FIG. 13 is a flow chart of a method 1300 for operating charging system 102. In a block 1302 of method 1300, controller 124 causes charging system 102 to operate in its first operating mode for one switching cycle of DC-to-DC converter 112. Method 1300 proceeds from block 1302 to a block 1304 where controller 124 causes charging system 102 to operate in its second operating mode for one switching cycle of DC-to-DC converter 112. Method 1300 proceeds from block 1304 to a block 1306 where controller 124 causes charging system 102 to operate in its third operating mode for one switching cycle of DC-to-DC converter 112. Method returns to block 1302 from block 1306, such that blocks 1302, 1304, and 1306 indefinitely repeat. Accordingly, charging system 102 operates in first, second, and third operating modes for equal durations of time when operating according to method 1300.

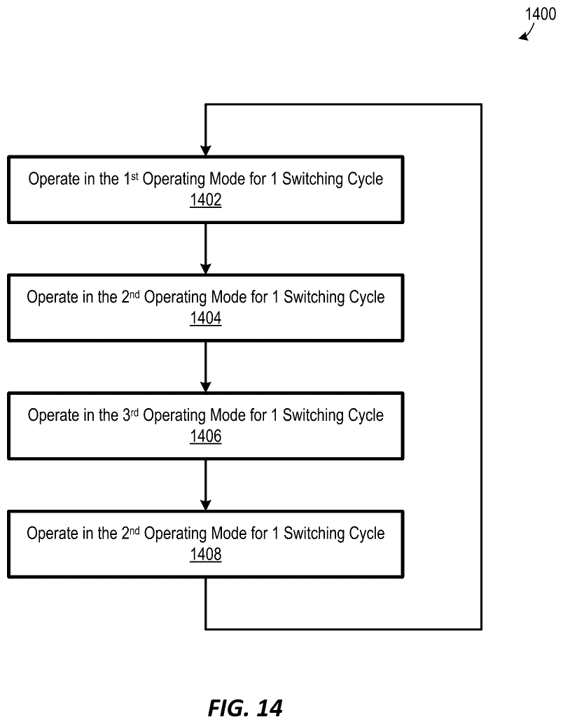

FIG. 14 is a flow chart of a method 1400 for operating charging system 102. In a block 1402 of method 1400, controller 124 causes charging system 102 to operate in its first operating mode for one switching cycle of DC-to-DC converter 112. Method 1400 proceeds from block 1402 to a block 1404 where controller 124 causes charging system 102 to operate in its second operating mode for one switching cycle of DC-to-DC converter 112. Method 1400 proceeds from block 1404 to a block 1406 where controller 124 causes charging system 102 to operate in its third operating mode for one switching cycle of DC-to-DC converter 112. Method 1400 proceeds from block 1406 to a block 1408 where controller 124 causes charging system 102 to operate in its second operating mode for one switching cycle of DC-to-DC converter 112. Method returns to block 1402 from block 1408, such that blocks 1402, 1404, 1406, and 1408 indefinitely repeat. Accordingly, charging system 102 operates in its second operating mode for a disproportionate amount of time when operating according to method 1400, such as in response to second load 110 requiring a large magnitude of current iₒ₂.

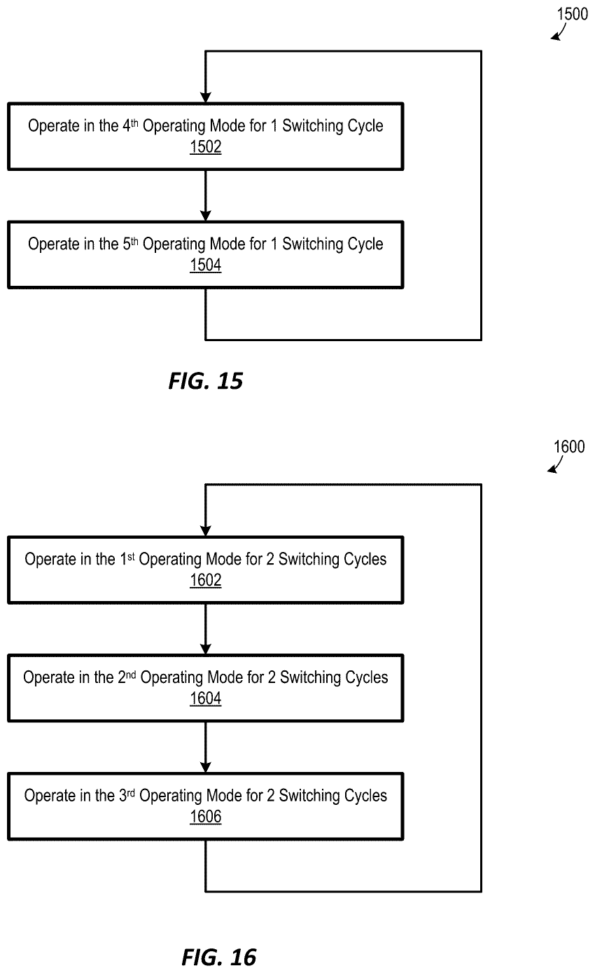

FIG. 15 is a flow chart of a method 1500 for operating charging system 102. In a block 1502 of method 1500, controller 124 causes charging system 102 to operate in its fourth operating mode for one switching cycle of DC-to-DC converter 112. Method 1500 proceeds from block 1502 to a block 1504 where controller 124 causes charging system 102 to operate in its fifth operating mode for one switching cycle of DC-to-DC converter 112. Method returns to block 1502 from block 1504, such that blocks 1502 and 1504 indefinitely repeat. Accordingly, charging system 102 operates in the fourth and fifth operating modes for equal durations of time when operating according to method 1500.

FIG. 16 is a flow chart of a method 1600 for operating charging system 102, which is similar to method 1300, except that controller 124 causes charging system 102 to operate in each of its first, second, and third operating modes for two switching cycles of DC-to-DC converter before switching to a different operating mode. In particular, in a block 1602 of method 1600, controller 124 causes charging system 102 to operate in its first operating mode for two consecutive switching cycles of DC-to-DC converter 112. Method 1600 proceeds from block 1602 to a block 1604 where controller 124 causes charging system 102 to operate in its second operating mode for two consecutive switching cycles of DC-to-DC converter 112. Method 1600 proceeds from block 1604 to a block 1606 where controller 124 causes charging system 102 to operate in its third operating mode for two consecutive switching cycles of DC-to-DC converter 112. Method returns to block 1602 from block 1606, such that blocks 1602, 1604, and 1606 indefinitely repeat. Accordingly, charging system 102 operates in first, second, and third operating modes for equal periods of time when operating according to method 1600.

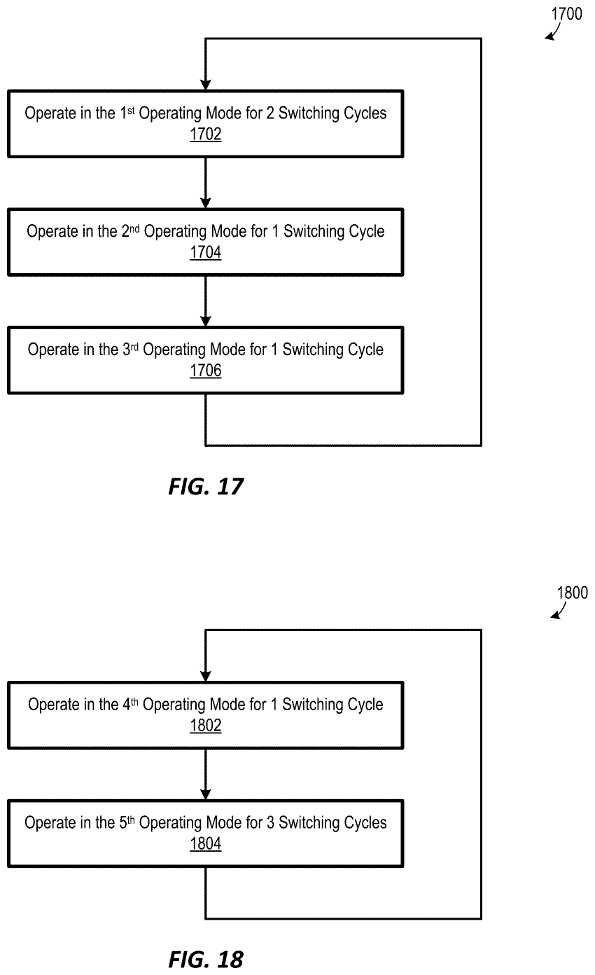

FIG. 17 is a flow chart of a method 1700 for operating charging system 102, which is similar to method 1300, except that controller 124 causes charging system 102 to operate in its first operating mode for a longer duration than charging system 102 operates in its second and third operating modes, such as to prioritize charging energy storage device 120 over powering first load 108 and second load 110. In particular, in a block 1702 of method 1700, controller 124 causes charging system 102 to operate in its first operating mode for two consecutive switching cycles of DC-to-DC converter 112. Method 1700 proceeds from block 1702 to a block 1704 where controller 124 causes charging system 102 to operate in its second operating mode for one switching cycle of DC-to-DC converter 112. Method 1700 proceeds from block 1704 to a block 1706 where controller 124 causes charging system 102 to operate in its third operating mode for one switching cycle of DC-to-DC converter 112. Method returns to block 1702 from block 1706, such that blocks 1702, 1704, and 1706 indefinitely repeat.

FIG. 18 is a flow chart of a method 1800 for operating charging system 102. In a block 1802 of method 1800, controller 124 causes charging system 102 to operate in its fourth operating mode for one switching cycle of DC-to-DC converter 112. Method 1800 proceeds from block 1802 to a block 1804 where controller 124 causes charging system 102 to operate in its fifth operating mode for three consecutive switching cycles of DC-to-DC converter 112. Method returns to block 1802 from block 1804, such that blocks 1802 and 1804 indefinitely repeat. Accordingly, charging system 102 disproportionally operates in the fifth operating modes when operating according to method 1800.

### Additional Features and Embodiments

Referring again to FIG. 1, it should be appreciated that while charging system 102 is capable of operating in multiple operating modes as discussed above, charging system 102 includes only a single inductor and only ten switching devices. Therefore, the configuration of charging system 102 promotes small size, low cost, and efficient operation. It is understood, though, that charging system 102 could be modified to include additional components, such as to add additional functionality, or to omit components, such as if functionality associated with particular components is not required. For example, as discussed above, each of first power conversion switching devices 146 and second power conversion switching devices 148 could be modified to add switching devices or to omit switching devices. Additionally, controller 124 could be modified to control one or more of first input switching device 116, second input switching device 118, first load switching device 150, second load switching device 152, and battery switching device 122 to perform a power conversion function in conjunction with inductor 144, thereby potentially enabling one or more switching devices to be omitted from first power conversion switching devices 146 and/or from second power conversion switching devices 148.

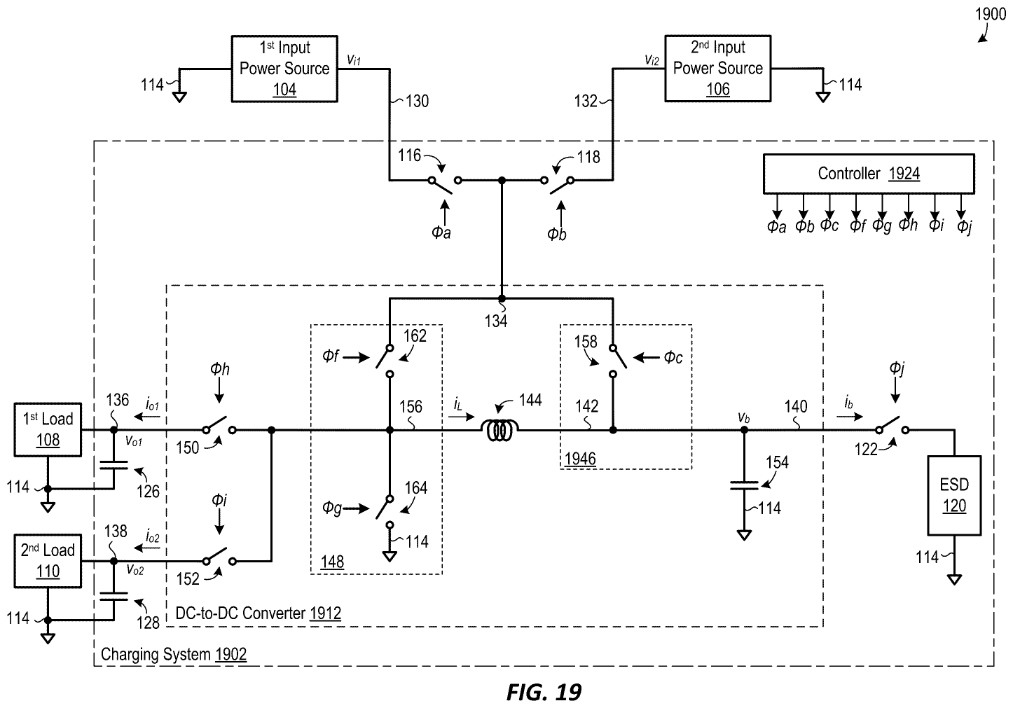

For example, FIG. 19 is a schematic diagram of an electrical environment 1900 including a charging system 1902 in place of charging system 102. Charging system 1902 differs from charging system 102 in that (a) DC-to-DC converter 112 is replaced with a DC-to-DC converter 1912 and (b) controller 124 is replaced with a controller 1924. DC-to-DC converter 1912 differs from DC-to-DC converter 112 in that first power conversion switching devices 146 are replaced with first power conversion switching devices 1946. First lower switching device 160 and first intermediate switching device 161 are omitted from first power conversion switching devices 1946.

Controller 1924 differs from controller 124 in that controller 1924 is not capable of generating control signals ϕd and ϕe. Additionally, controller 1924 is configured to generate controls signals in somewhat different manner than controller 124 in view first lower switching device 160 and first intermediate switching device 161 being omitted. In particular, in the first operating mode of charging system 1902, controller 1924 generates control signals in a manner similar to that discussed above with respect to FIG. 4, although controller 1924 does not generate control signals ϕd and ϕe because their respective switching devices are omitted. In the second operating mode of charging system 1902, however, (a) controller 1924 generates control signal ϕg to control duty cycle of second lower switching device 164 to regulate one or more of magnitude of voltage vₒ₁ and magnitude of current iₒ₁, and (b) controller 1924 generates control signal ϕh such that first load switching device 150 performs a freewheeling function, i.e., it provides a path for current i_{L} flowing through inductor 144 when second lower switching device 164 is open. Additionally, controller 1924 generates control signals ϕc and ϕj such that first upper switching device 158 is closed and battery switching device 122 is open, respectively. Accordingly, DC-to-DC converter 1912 operates as a boost converter in the second operating mode of charging system 1902. DC-to-DC converter 1912 operates in a similar manner in the third operating mode of charging system 1902, except that second load switching device 152, instead of first load switching device 150, performs a freewheeling function.

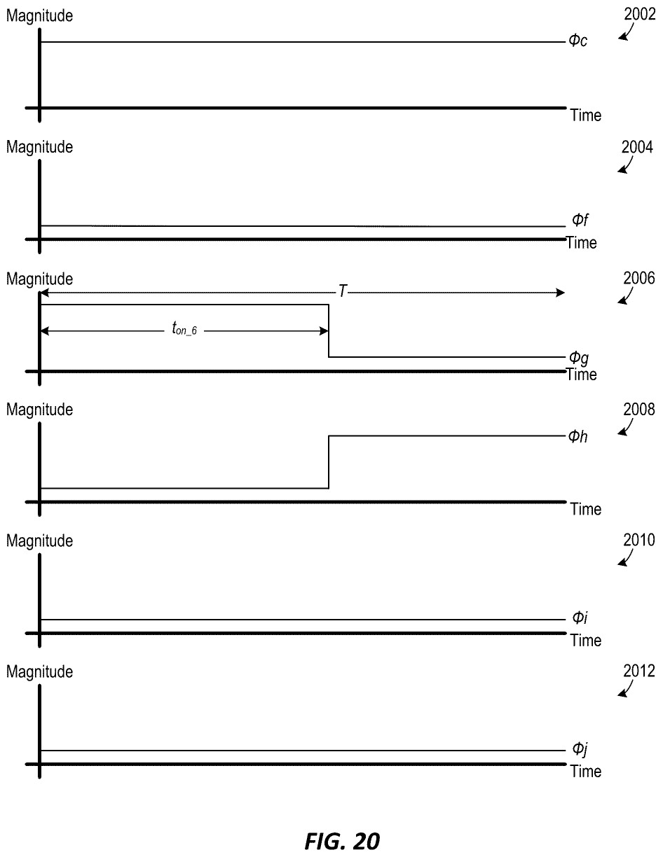

FIG. 20 includes six graphs 2002, 2004, 2006, 2008, 2010, and 2012 respectively illustrating one example of how controller 1924 may generate control signals ϕc, ϕf, ϕg, ϕh, ϕi, and ϕj during a single switching cycle of DC-to-DC converter 1912 in the second operating mode of charging system 1902. Each of graphs 2002, 2004, 2006, 2008, 2010, and 2012 is of signal magnitude versus time, and each of graphs 2002, 2004, 2006, 2008, 2010, and 2012 shares a common time base. In the example of FIG. 20, control signals ϕf, ϕi, and ϕj are continuously logic low, and second upper switching device 162, second load switching device 152, and battery switching device 122 therefore continuously operate in their respective open states. Control signal ϕc, in contrast, is continuously logic high, and first upper switching device 158 therefore continuously operates in its closed state. Control signal ϕg switches between logic high and logic low states with a duty cycle of t_{on_6}/T. Additionally, control signal ϕh is complementary to control signal ϕg, such that DC-to-DC converter 1912 operates in a continuous current conduction mode. It is understood, though, that FIG. 20 is not meant to constrain DC-to-DC converter 1912 to any particular duty cycle or to any particular mode of operation. For example, DC-to-DC converter 1912 may instead operate in a discontinuous current conduction mode. Actual operation of DC-to-DC converter 1912 is, for example, implementation dependent and/or operating environment dependent.

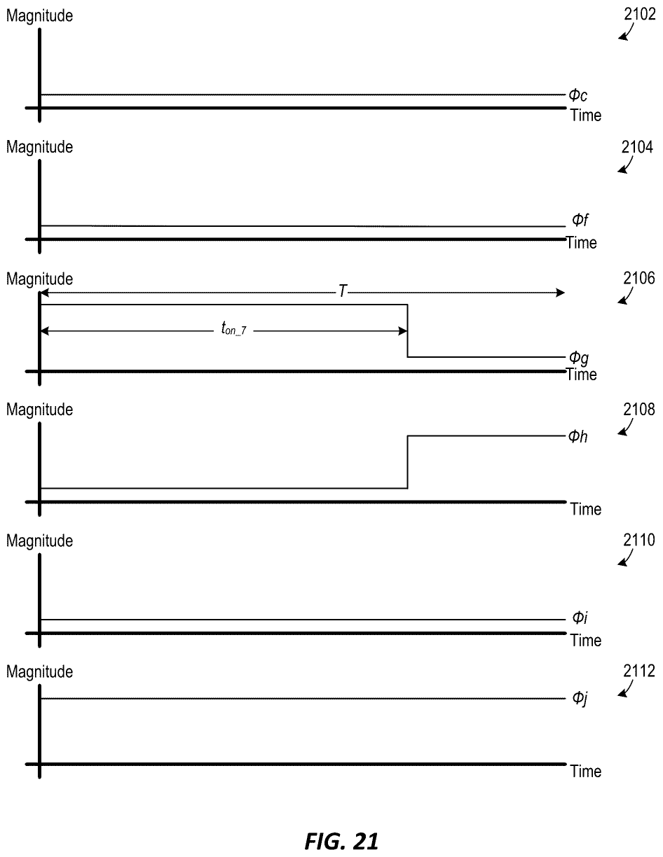

The fourth and fifth operating modes of charging system 1902 are like the second and third operating modes, respectively, except that (a) first upper switching device 158 is continuously open and battery switching device 122 is continuously closed. For example, FIG. 21 includes six graphs 2102, 2104, 2106, 2108, 2110, and 2112 respectively illustrating one example of how controller 1924 may generate control signals ϕc, ϕf, ϕg, ϕh, ϕi, and ϕj during a single switching cycle of DC-to-DC converter 1912 in the fourth operating mode of charging system 1902. Each of graphs 2102, 2104, 2106, 2108, 2110, and 2112 is of signal magnitude versus time, and each of graphs 2102, 2104, 2106, 2108, 2110, and 2112 shares a common time base. In the example of FIG. 21, control signals ϕc ϕf, and ϕi are continuously logic low, and first upper switching device 158, second upper switching device 162, and second load switching device 152 therefore continuously operate in their respective open states. Control signal ϕj, in contrast, is continuously logic high, and battery switching device 122 therefore continuously operates in its closed state. Control signal ϕg switches between logic high and logic low states with a duty cycle of t_{on_7}/T. Additionally, control signal ϕh is complementary to control signal ϕg, such that DC-to-DC converter 1912 operates in a continuous current conduction mode. It is understood, though, that FIG. 21 is not meant to constrain DC-to-DC converter 1912 to any particular duty cycle or to any particular mode of operation. For example, DC-to-DC converter 1912 may instead operate in a discontinuous current conduction mode. Actual operation of DC-to-DC converter 1912 is, for example, implementation dependent and/or operating environment dependent.

Referring again to FIG. 1, in some embodiments first input power source 104 and/or second input power source 106 have a non-linear relationship between voltage and current. For example, in certain embodiments, second input power source 106 is a photovoltaic assembly having a non-linear relationship between voltage vᵢ₂ and a current iᵢ₂ flowing through second input power source 106. As known in the art, a non-linear electric power source will not necessarily operate at its maximum power point unless a load powered by the non-linear electric power source is controlled to present an impedance which maximizes power transfer between the non-linear electric power source and the load.

According, certain embodiments of controller 124 are configured to control operation of charging system 102 in one or more of the first operating mode, the second operating mode, and the third operating mode, to perform maximum power point tracking (MPPT) with respect to first input power source 104 and/or second input power source 106 to at least substantially maximize transfer of power from the input power source to charging system 102. For example, some embodiments of controller 124 are configured to control operation of DC-to-DC converter 112 in the first, second, and/or third operating mode to control an input impedance Zᵢ₁, which is impedance of charging system 102 seen by first input power source 104, to at least substantially maximize power transfer from first input power source 104 to charging system 102. As another example, particular embodiments of controller 124 are configured to control operation of DC-to-DC converter 112 in the first, second, and/or third operating mode to control an input impedance Zᵢ₂, which is impedance of charging system 102 seen by second input power source 106, to at least substantially maximize power transfer from second input power source 106 to charging system 102. Controller 124 determines input impedance Zᵢ₁ or Zᵢ₂ to at least substantially maximizes power transfer, for example, using a perturb and observe procedure where controller 124 incrementally varies duty cycle of DC-to-DC converter 112 until DC-to-DC converter 112 converges to a duty cycle which maximizes transfer for power from first input power source 104 or second input power source 106 to charging system 102.

In some applications one or more of first input power source 104 and/or second input power source 106 may from time to time be replaced with a load. For example, in embodiments of electrical environment 100 where first input power source 104 is a USB power source, the USB power source could be replaced with a USB load, such as when a user of charging system 102 is OTG and the user desires to power a USB load from charging system 102. Accordingly, some embodiments of controller 124 are further configured to support one or more additional operating modes of charging system 102 where charging system 102 powers a load electrically coupled to first input power node 130, and/or a load electrically coupled to second input power node 132, using energy stored in energy storage device 120.

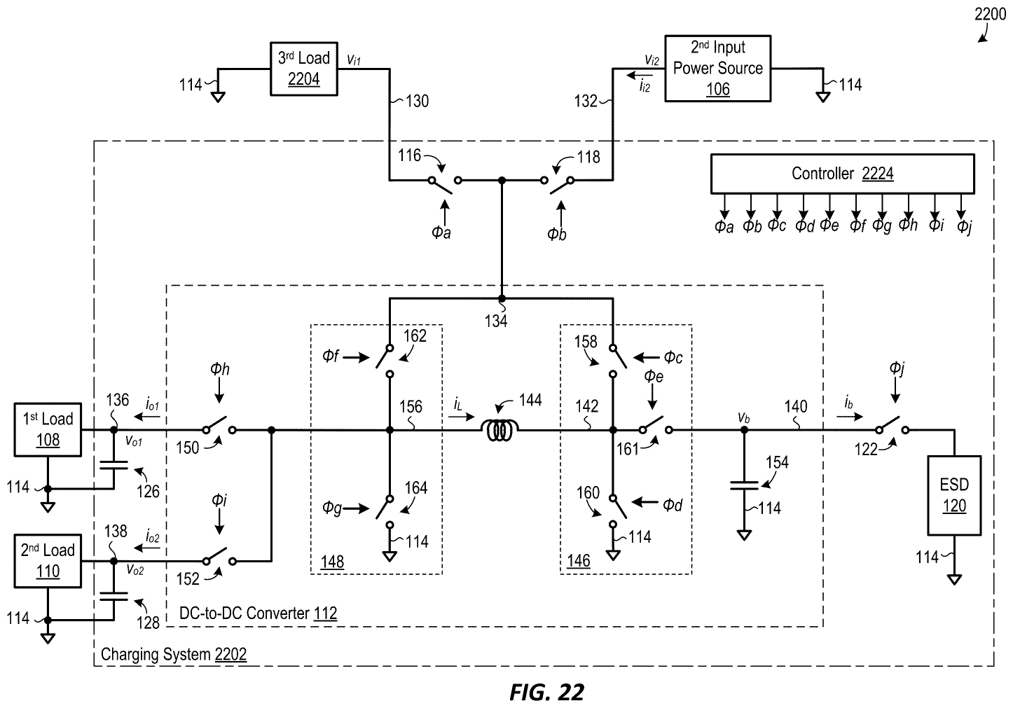

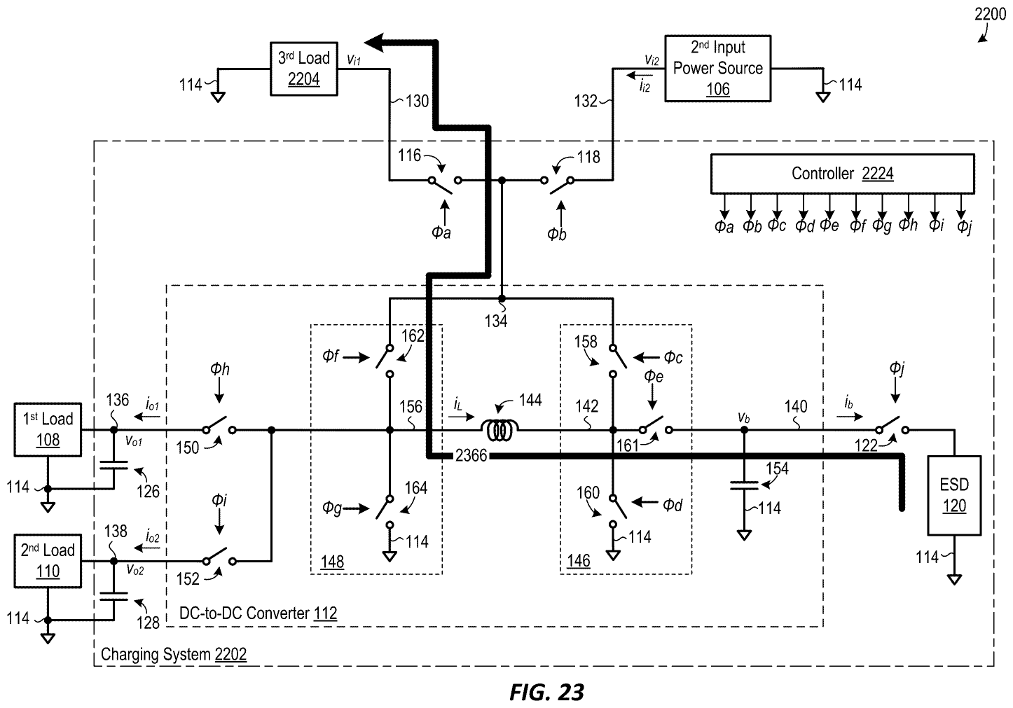

For example, FIG. 22 is a schematic diagram of an electrical environment 2200, which is an alternate embodiment of electrical environment 100 (FIG. 1) where (a) first input power source 104 is replaced with a third load 2204 and (b) charging system 102 is replaced with a charging system 2202. Charging system 2202 differs from charging system 102 in that charging system 2202 includes a controller 2224 in place of controller 124. Controller 2224 includes the function of controller 124, and controller 2224 is further capable of generating control signals to cause charging system 2202 to operate in one or more additional operating modes where charging system 2202 powers third load 2204 from energy stored in energy storage device 120. For example, FIG. 23 is a schematic diagram of electrical environment 2200 illustrating one example of operation of charging system 2202 in a sixth operating mode where charging system 2202 charges third load 2204 from energy stored in energy storage device 120. FIG. 23 includes heavy lines 2366 symbolically showing that DC-to-DC converter 112 transfers energy from energy storage device 120 to third load 2204. Energy flows through inductor 144 from right to left, i.e., from first switching node 142 to second switching node 156, in the sixth operating mode. As such, a DC component of current i_{L} flowing through inductor 144 will be negative.

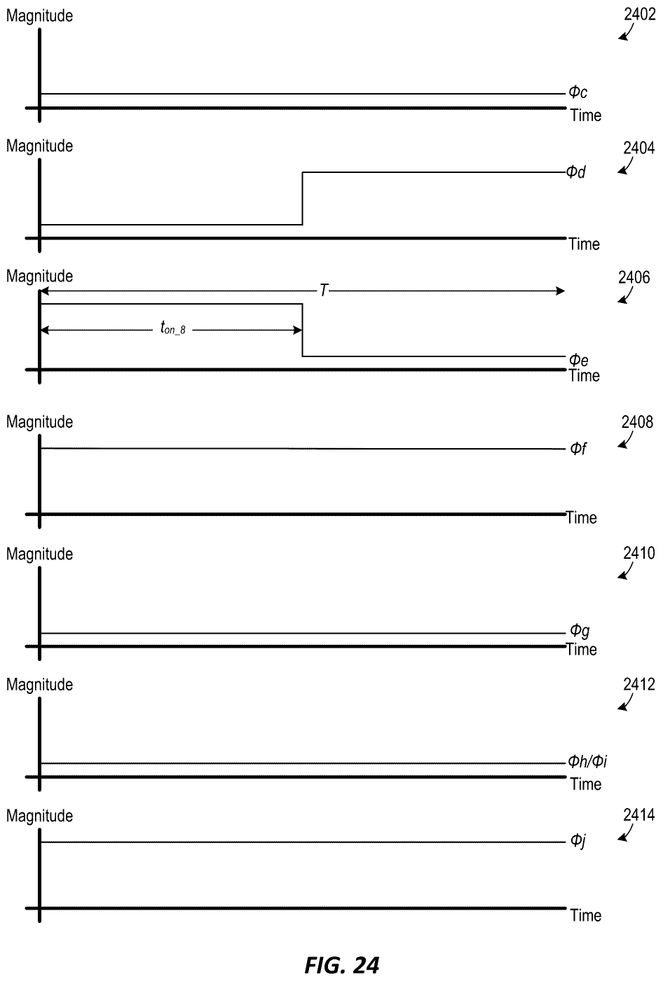

Referring again to FIG. 22, controller 2224 could be configured to cause DC-to-DC converter 112 to operate either as a buck converter or as a boost converter when transferring energy from energy storage device 120 to third load 2204. For example, FIG. 24 includes seven graphs 2402, 2404, 2406, 2408, 2410, 2412, and 2414 respectively illustrating one example of how controller 2224 may generate control signals ϕc, ϕd, ϕe, ϕf, ϕg, ϕh/ϕi, and ϕj during a single switching cycle of DC-to-DC converter 112 of charging system 2202 in the sixth operating mode where DC-to-DC converter 112 operates as a buck converter. Each of graphs 2402, 2404, 2406, 2408, 2410, 2412, and 2414 is of signal magnitude versus time, and each of graphs 2402, 2404, 2406, 2408, 2410, 2412, and 2414 shares a common time base. In the example of FIG. 24, control signals ϕc, ϕg, ϕh, and ϕi are continuously logic low, and first upper switching device 158, second lower switching device 164, first load switching device 150, and second load switching device 152 therefore continuously operate in their respective open states. Control signals ϕf and ϕj, in contrast, are continuously logic high, and second upper switching device 162 and battery switching device 122 therefore continuously operates in their closed states. Additionally, while not illustrated in FIG. 24, it is assumed that first input switching device 116 is continuously closed, and that second input switching device 118 is continuously open, in the example of FIG. 24. Control signal ϕe switches between logic high and logic low states with a duty cycle of t_{on_8}/T. Additionally, control signal ϕd is complementary to control signal de, such that DC-to-DC converter 112 operates in a continuous current conduction mode. It is understood, though, that FIG. 24 is not meant to constrain DC-to-DC converter 112 to any particular duty cycle or to any particular mode of operation. For example, DC-to-DC converter 112 may instead operate in a discontinuous current conduction mode. Actual operation of DC-to-DC converter 112 is, for example, implementation dependent and/or operating environment dependent.

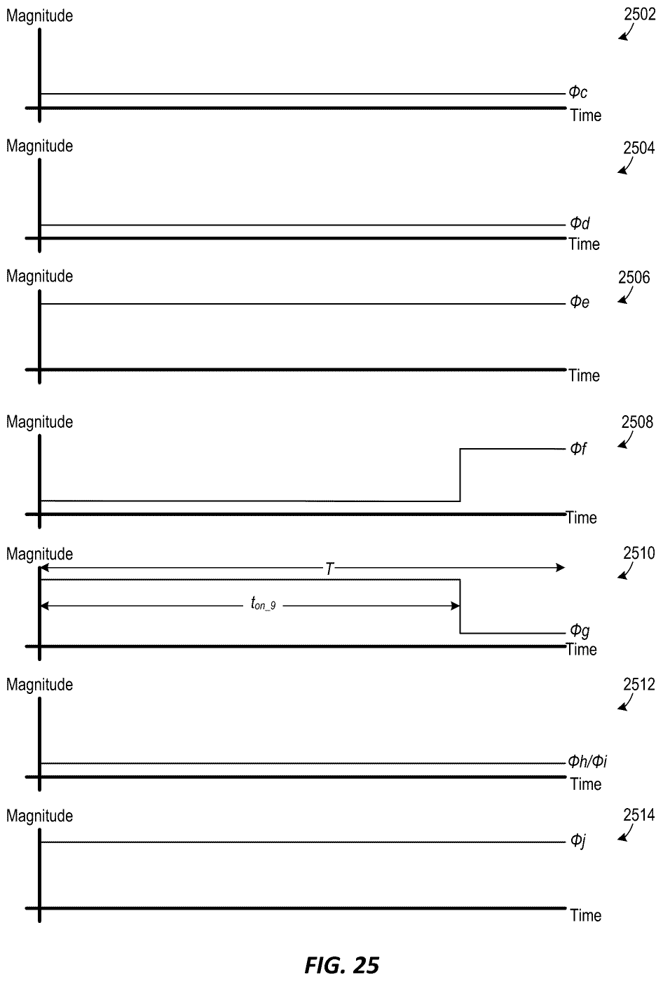

FIG. 25 includes seven graphs 2502, 2504, 2506, 2508, 2510, 2512, and 2514 respectively illustrating one example of how controller 2224 may generate control signals ϕc, ϕd, ϕe, ϕf, ϕg, ϕh/ϕi, and ϕj during a single switching cycle of DC-to-DC converter 112 of charging system 2202 in the sixth operating mode where DC-to-DC converter 112 operates as a boost converter. Each of graphs 2502, 2504, 2506, 2508, 2510, 2512, and 2514 is of signal magnitude versus time, and each of graphs 2502, 2504, 2506, 2508, 2510, 2512, and 2514 shares a common time base. In the example of FIG. 25, control signals ϕc, ϕd, ϕh, and ϕi are continuously logic low, and first upper switching device 158, first lower switching device 160, first load switching device 150, and second load switching device 152 therefore continuously operate in their respective open states. Control signals ϕe and ϕj, in contrast, are continuously logic high, and first intermediate switching device 161 and battery switching device 122 therefore continuously operates in their closed states. Additionally, while not illustrated in FIG. 25, it is assumed that first input switching device 116 is continuously closed, and that second input switching device 118 is continuously open, in the example of FIG. 25. Control signal ϕg switches between logic high and logic low states with a duty cycle of t_{on_9}/T. Additionally, control signal ϕf is complementary to control signal ϕg, such that DC-to-DC converter 112 operates in a continuous current conduction mode. It is understood, though, that FIG. 24 is not meant to constrain DC-to-DC converter 112 to any particular duty cycle or to any particular mode of operation. For example, DC-to-DC converter 112 may instead operate in a discontinuous current conduction mode. Actual operation of DC-to-DC converter 112 is, for example, implementation dependent and/or operating environment dependent. In some alternate embodiments, charging system 2202 is configured to such that first input switching device 116, instead of second upper switching device 162, performs a freewheeling function when DC-to-DC converter 112 operates as a boost converter in the sixth operating mode.

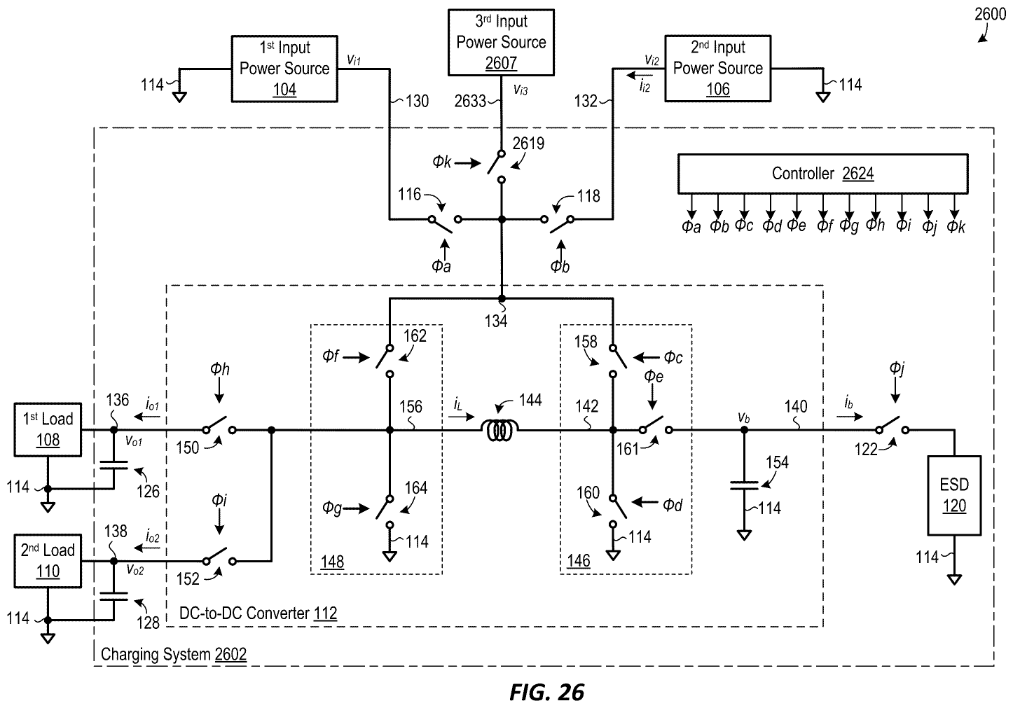

Referring again to FIG. 1, electrical environment 100 may be modified to include a different quantity of input power sources and/or loads. Additionally, charging system 102 could be modified to include additional energy storage devices. Discussed below with respect to FIGS. 26-28 are a few example alternate embodiments of electrical environment 100 including additional elements. It is understood, though, that many other alternate embodiments of electrical environment 100 are possible in addition to those of the examples of FIGS. 26-28.

FIG. 26 is a schematic diagram of an electrical environment 2600, which is an alternate embodiment of electrical environment 100 further including a third input power source 2607, as well a charging system 2602 in place of charging system 102. Third input power source 2607 is electrically coupled to a third input power node 2633, and third input power source 2607 is configured to drive third input power node 2633 to an input voltage vᵢ₃. Charging system 2602 differs from charging system 102 in that (a) charging system 2602 further includes a third input switching device 2619, and (b) charging system 2602 includes a controller 2624 in place of controller 124. Third input switching device 2619 is electrically coupled between third input power node 2633 and intermediate power node 134, and third input switching device 2619 is accordingly configured to selectively electrically couple intermediate power node 134 to third input power source 2607 in response to a control signal ϕk generated by controller 2624. Controller 2624 differs from controller 124 in that controller 2624 further generates control signal ϕk. Controller 2624 is configured to select third input power source 2607 for charging energy storage device 120 in the first operating mode, for powering first load 108 in the second operating mode, or for powering second load 110 in the third operating mode, by (a) causing each of first input switching device 116 and second input switching device 118 to be open, and (b) causing third input switching device 2619 to be closed.

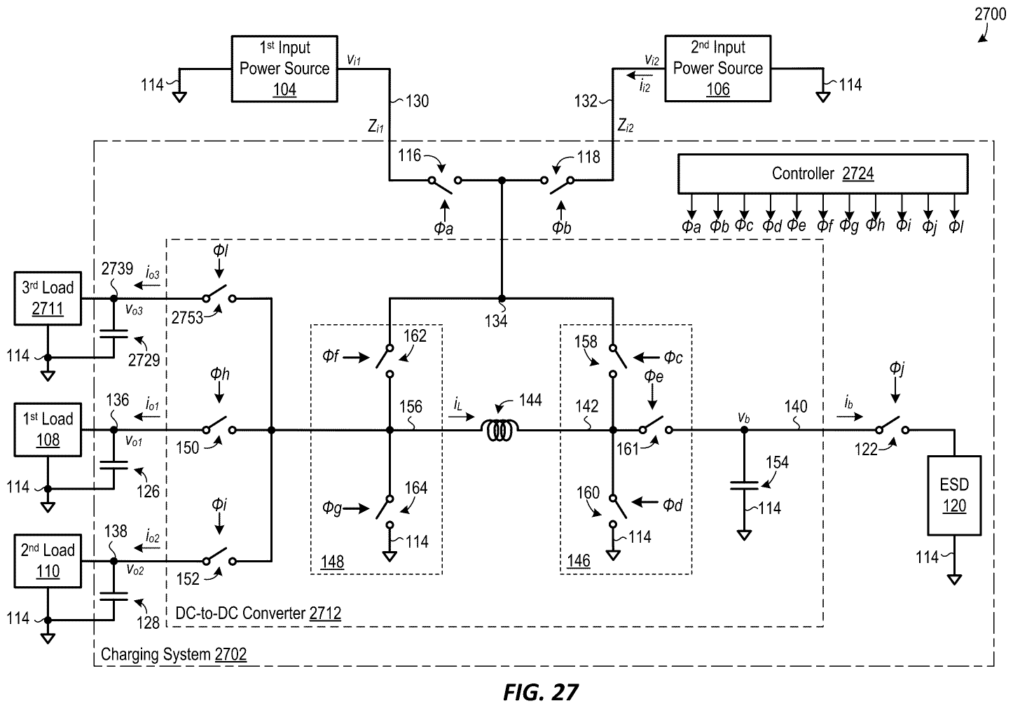

FIG. 27 is a schematic diagram of an electrical environment 2700, which is an alternate embodiment of electrical environment 100 further including a third load 2711 and a third output capacitor 2729, as well a charging system 2702 in place of charging system 102. Third load 2711 is electrically coupled to a third output power node 2739, and third output capacitor 2729 is electrically coupled between third output power node 2739 and reference node 114. Third output capacitor 2729 may be omitted in embodiments where third load 2711 includes sufficient capacitance so that third output capacitor 2729 is not needed.

Charging system 2702 differs from charging system 102 in that (a) charging system 2702 includes a DC-to-DC converter 2712 in place of DC-to-DC converter 112, and (b) charging system 2702 includes a controller 2724 in place of controller 124. DC-to-DC converter 2712 differs from DC-to-DC converter 112 in that DC-to-DC converter 2712 further includes a third load switching device 2753 electrically coupled between second switching node 156 and third output power node 2739, where third load switching device 2753 is configured to selectively electrically couple third load 2711 to second switching node 156 in response to a control signal ϕl generated by controller 2724. Controller 2724 differs from controller 124 in that controller 2724 further generates control signal ϕl. Controller 2724 is configured to support two additional operating mode of charging system 2702 where third load 2711 is powered from an input power source (104 or 106) or from energy storage device 120, respectively. For example, particular embodiments of controller 2724 support an additional operating where third load 2711 is powered from an input power source 104 or 106 by operating in the same manner as discussed above with respect to the second operating mode, but with (a) first load switching device 150 being open instead of being closed and (b) third load switching device 2753 being closed. As another example, some embodiments of controller 2724 support a further operating where third load 2711 is powered from energy storage device 120 by operating in the same manner as discussed above with respect to the fourth operating mode, but with (a) first load switching device 150 being open instead of being closed and (b) third load switching device 2753 being closed. Particular embodiments of controller 2724 are configured to regulate magnitude of voltage vₒ₃ and/or current iₒ₃ independent of each of magnitude of voltage v₀₁, magnitude of voltage vₒ₂, magnitude of current i₀₁, and magnitude of current iₒ₂, due to each of first load 108 and second load 110 being isolated from DC-to-DC converter 2712 by first load switching device 150 and second load switching device 152, respectively, when third load 2711 is electrically coupled to DC-to-DC converter 2712 by third load switching device 2753.

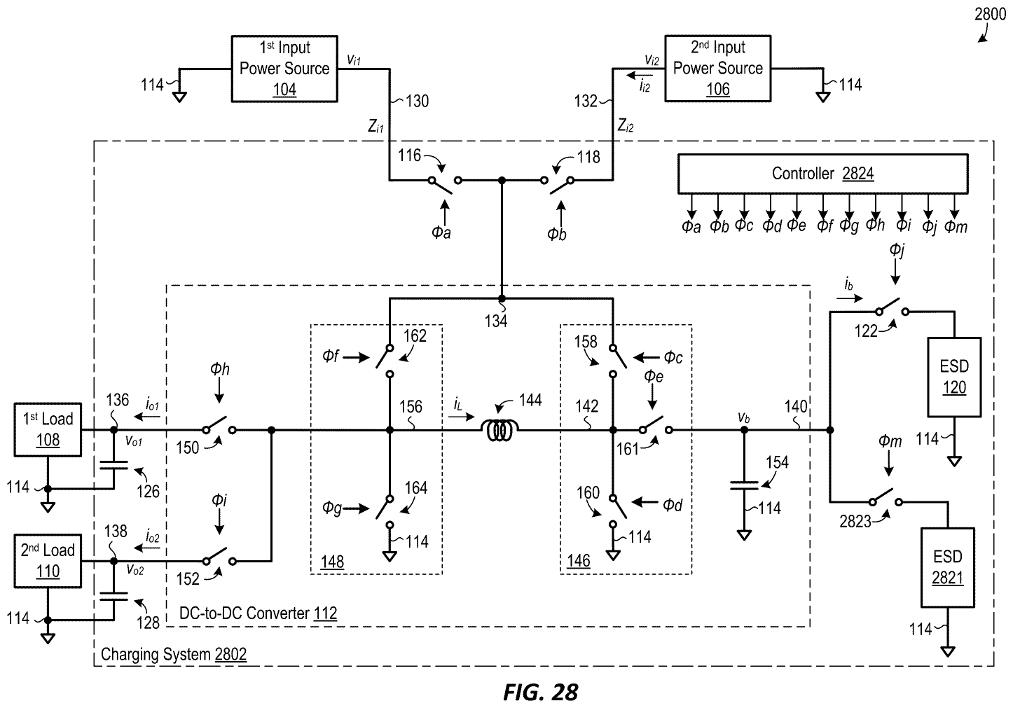

FIG. 28 is a schematic diagram of an electrical environment 2800 including a charging system 2802 in place of charging system 102. Charging system 2802 differs from charging system 102 in that (a) charging system 2802 further includes a second energy storage device 2821 and a second battery switching device 2823, and (b) charging system 2802 includes a controller 2824 in place of controller 124. In some embodiments, second energy storage device 2821 has the same configuration as energy storage device 120, while in some other embodiments, second energy storage device 2821 has a different configuration than energy storage device 120. Second energy storage device 2821 includes one more elements capable of storing energy, such as one or more batteries, one or more capacitors, etc. Second energy storage device 2821 is electrically coupled to battery node 140 via second battery switching device 2823. Accordingly, second energy storage device 2821 is electrically coupled to battery node 140 and to DC-to-DC converter 112 via second battery switching device 2823. Second battery switching device 2823 is configured to selectively electrically couple second energy storage device 2821 to battery node 140 in response to a control signal ϕm generated by controller 2824.

Controller 2824 differs from controller 124 in that controller 2824 is further configured to generate control signal ϕm. Controller 2824 is configured to generate control signals ϕj and ϕm, for example, to select one of energy storage device 120 and second energy storage device 2821, to be charged by one of first input power source 104 and second input power source 106, or to power one of first load 108 and second load 110. For example, controller 2824 selects energy storage device 120 to be charged, or to power a load, (a) by causing battery switching device 122 to be closed and (c) by causing second battery switching device 2823 to be open. As another example, controller 2824 selects second energy storage device 2821 to be charged, or to power a load, (a) by causing battery switching device 122 to be open and (c) by causing second battery switching device 2823 to be closed. As an additional example, controller 2824 selects both of energy storage device 120 and second energy storage device 2821 to be charged, or to power a load, by causing each of battery switching device 122 and second battery switching device 2823 to be closed.

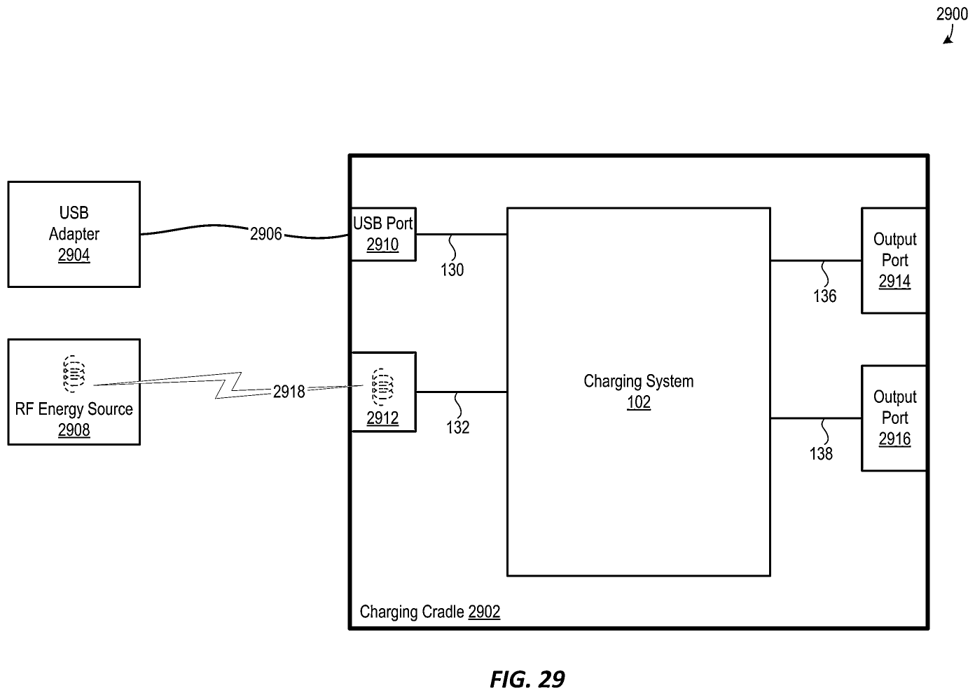

One possible application of the new charging systems disclosed herein is in use in a charging cradle, such as a charging cradle for charging portable electronic devices. For example, FIG. 29 is a block diagram of an electrical environment 2900 including a charging cradle 2902, an USB adapter 2904, a USB cable 2906, and a radio frequency (RF) energy source 2908. Charging cradle 2902 includes an embodiment of charging system 102 (FIG. 1), an USB port 2910, a wireless charging port 2912, an output port 2914, and an output port 2916. Details of charging system 102 are not shown in FIG. 29 for illustrative clarity. USB port 2910 is configured to electrically interface USB adapter 2904 with charging cradle 2902 via USB cable 2906, and USB port 2910 thereby enables charging cradle 2902 to receive electrical power from USB adapter 2904. USB port 2910 is an embodiment of first input power source 104, and USB port 2910 is accordingly electrically coupled to charging system 102 via first input power node 130.

Wireless charging port 2912 is configured to generate electrical power from a dynamic magnetic field 2918 generated by RF energy source 2908. In some embodiments, wireless charging port 2912 includes a coil, symbolically shown by dashed lines in FIG. 29, for inducement of an electric current by dynamic magnetic field 2918, as well as power regulation circuitry (not shown) to provide a regulated electric power source for charging cradle 2902. Particular embodiments of RF energy source 2908 include a resonant coil, symbolically shown by dashed lines in FIG. 29, for generating dynamic magnetic field 2918 from an external electrical power source (not shown). Wireless charging port 2912 is an embodiment of second input power source 106, and wireless charging port 2912 is accordingly electrically coupled to charging system 102 via second input power node 132.

Output port 2914 is electrically coupled to first output power node 136, and output port 2914 enables a first portable electronic device (not shown), which is an embodiment of first load 108, to be powered from charging cradle 2902 via first output power node 136. Similarly, output port 2916 is electrically coupled to second output power node 138, and output port 2916 enables a second portable electronic device (not shown), which is an embodiment of second load 110, to be powered from charging cradle 2902 via second output power node 138.

### Combinations of Features

Features described above may be combined in various ways without departing from the scope hereof. The following examples illustrate some possible combinations.
(A1) A charging system includes (1) a multi-function direct-current-to-direct-current (DC-to-DC) converter, (2) an energy storage device, and (3) a controller. The controller is configured to control at least the multi-function DC-to-DC converter to enable the charging system to operate in at least any one of the following operating modes: (i) a first operating mode at least partially characterized by the multi-function DC-to-DC converter charging the energy storage device using energy from an input power source, (ii) a second operating mode at least partially characterized by the multi-function DC-to-DC converter powering a first load using energy from the input power source, and (ii) a third operating mode at least partially characterized by the multi-function DC-to-DC converter powering a second load using energy from the input power source.
(A2) In the charging system denoted as (A1), the controller may be further configured to control the multi-function DC-to-DC converter in the second operating mode to regulate at least one of magnitude of voltage at the first load and magnitude of current flowing through the first load, independent of each of magnitude of voltage at the second load and magnitude of current flowing through the second load.
(A3) In either one of the charging systems denoted as (A1) and (A2), the controller may be further configured to control at least the multi-function DC-to-DC converter to cause the charging system to repeatedly switch between at least the second operating mode and the third operating mode.
(A4) In any one of the charging systems denoted as (A1) through (A3), the controller may be further configured to control at least the multi-function DC-to-DC converter to cause the charging system to repeatedly switch between at least the first operating mode, the second operating mode, and the third operating mode.
(A5) In any one of the charging systems denoted as (A1) through (A4), (1) the multi-function DC-to-DC converter may include an inductor and a plurality of switching devices electrically coupled to the inductor, and (2) the controller may be configured to control operation of the plurality of switching devices electrically coupled to the inductor to change a topology of the multi-function DC-to-DC converter according to an operating mode of the charging system.
(A6) In the charging system denoted as (A5), (1) energy may flow through the inductor in a first direction in the first operating mode and (2) energy may flow through the inductor in a second direction in each of the second operating mode and the third operating mode, the second direction being opposite of the first direction.
(A7) In any one of the charging systems denoted as (A1) through (A6), the controller may be further configured to control at least the multi-function DC-to-DC converter to enable the charging system to operate in any one of the following additional operating modes: (1) a fourth operating mode at least partially characterized by the multi-function DC-to-DC converter powering the first load using energy stored in the energy storage device and (2) a fifth operating mode at least partially characterized by the multi-function DC-to-DC converter powering the second load using energy stored in the energy storage device.
(A8) In the charging system denoted as (A7), the controller may be further configured to control the multi-function DC-to-DC converter in the fourth operating mode to regulate at least one of magnitude of voltage at the first load and magnitude of current flowing through the first load, independent of each of magnitude of voltage at the second load and magnitude of current flowing through the second load.
(A9) In the charging system denoted as (A8), the controller may be further configured to control the multi-function DC-to-DC converter in the fifth operating mode to regulate at least one of magnitude of the voltage at the second load and magnitude of the current flowing through the second load, independent of each of magnitude of the voltage at the first load and magnitude of the current flowing through the first load.
(A10) In any one of the charging systems denoted as (A1) through (A9), the controller may be further configured to control at least the multi-function DC-to-DC converter to cause the charging system to repeatedly switch between at least the fourth operating mode and the fifth operating mode.
(A11) In any one of the charging systems denoted as (A1) through (A10), the controller may be further configured to control the multi-function DC-to-DC converter in the first operating mode to perform maximum power point tracking (MPPT) with respect to the input power source.
(A12) In any one of the charging systems denoted as (A1) through (A11), the controller may be further configured to control at least the multi-function DC-to-DC converter to enable the charging system to operate in an additional operating mode at least partially characterized by the multi-function DC-to-DC converter powering an additional load using energy stored in the energy storage device, the additional load replacing the input power source.
(B1) A charging system includes (1) an inductor electrically coupled between a first switching node and a second switching node, (2) one or more first power conversion switching devices electrically coupled to the first switching node, (3) one or more second power conversion switching devices electrically coupled to the second switching node, (4) a first load switching device electrically coupled between the second switching node and a first output power node, (5) a second load switching device electrically coupled between the second switching node and a second output power node, (6) an energy storage device electrically coupled to the first switching node via at least the one or more first power conversion switching devices, and (7) a controller. The controller is configured to control at least the one or more first power conversion switching devices, the one or more second power conversion switching devices, the first load switching device, and the second load switching device to enable the charging system to operate in at least any one of the following operating modes: (i) a first operating mode at least partially characterized by the charging system charging the energy storage device using energy from an input power source, (ii) a second operating mode at least partially characterized by the charging system powering a first load electrically coupled to the first output power node using energy from the input power source, and (iii) a third operating mode at least partially characterized by the charging system powering a second load electrically coupled to the second output power node using energy from the input power source.
(B2) In the charging system denoted as (B1), (i) the first operating mode may be further characterized by energy from the input power source flowing through the inductor from the second switching node to the first switching node, (ii) the second operating mode may be further characterized by energy from the input power source flowing through the inductor from the first switching node to the second switching node, and (iii) the third operating mode may be further characterized by energy from the input power source flowing through the inductor from the first switching node to the second switching node.
(B3) In either one of the charging systems denoted as (B1) and (B2), the controller may be further configured to control at least the one or more first power conversion switching devices and the one or more second power conversion switching devices to regulate at least one of magnitude of voltage at the first load and magnitude of current flowing through the first load, independent of each of magnitude of voltage at the second load and magnitude of current flowing through the second load.
(B4) In any one of the charging systems denoted as (B1) through (B3), the controller may be further configured to control at least the multi-function DC-to-DC converter to cause the charging system to repeatedly switch between at least the second operating mode and the third operating mode.
(B5) In any one of the charging systems denoted as (B1) through (B3), the controller may be further configured to control at least the one or more first power conversion switching devices, the one or more second power conversion switching devices, the first load switching device, and the second load switching device to cause the charging system to repeatedly switch between the first operating mode, the second operating mode, and the third operating mode.
(B6) In any one of the charging systems denoted as (B1) through (B5), the controller may be further configured to control at least the one or more first power conversion switching devices, the one or more second power conversion switching devices, the first load switching device, and the second load switching device to enable the charging system to operate in any one of the following additional operating modes: (1) a fourth operating mode at least partially characterized by the charging system powering the first load using energy stored in the energy storage device and (2) a fifth operating mode at least partially characterized by the charging system powering the second load using energy stored in the energy storage device.
(B7) In any one of the charging may include denoted as (B1) through (B6), (1) the one or more first power conversion switching devices may include an upper switching device electrically coupled between an intermediate power node and the first switching node, the intermediate power node being configured to be electrically coupled to the input power source, and (2) the one or more second power conversion switching devices may include a lower switching device electrically coupled between the second switching node and a reference node.
(B8) In any one of the charging may include denoted as (B1) through (B6), (1) the one or more first power conversion switching devices may include a first lower switching device electrically coupled between the first switching node and a reference node, and (2) the one or more second power conversion switching devices may include (i) an upper switching device electrically coupled between an intermediate power node and the second switching node, the intermediate power node being configured to be electrically coupled to the input power source and (ii) a second lower switching device electrically coupled between the second switching node and the reference node.
(C1) A method for operating a charging system includes (1) transferring first energy from an input power source to an energy storage device using a multi-function direct-current-to-direct-current (DC-to-DC) converter by transferring first energy through an inductor of the multi-function DC-to-DC converter in a first direction, (2) after transferring the first energy from the input power source to the energy storage device, transferring second energy from one of the input power source and the energy storage device to a first load using the multi-function DC-to-DC converter by transferring the second energy through the inductor of the multi-function DC-to-DC converter in a second direction that is opposite of the first direction, and (3) after transferring the second energy from one of the input power source and the energy storage device to the first load, transferring third energy from one of the input power source and the energy storage device to a second load using the multi-function DC-to-DC converter by transferring the third energy through the inductor of the multi-function DC-to-DC converter in the second direction.
(C2) The method denoted as (C1) may further include controlling the multi-function DC-to-DC converter to regulate a magnitude of a voltage at the first load independently of a magnitude of a voltage at the second load.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A charging system, comprising:
a multi-function direct-current-to-direct-current (DC-to-DC) converter;
an energy storage device; and
a controller configured to control at least the multi-function DC-to-DC converter to enable the charging system to operate in at least any one of the following operating modes:
a first operating mode at least partially characterized by the multi-function DC-to-DC converter charging the energy storage device using energy from an input power source,
a second operating mode at least partially characterized by the multi-function DC-to-DC converter powering a first load using energy from the input power source, and
a third operating mode at least partially characterized by the multi-function DC-to-DC converter powering a second load using energy from the input power source.

2. The charging system of claim 1, wherein the controller is further configured to control the multi-function DC-to-DC converter in the second operating mode to regulate at least one of magnitude of voltage at the first load and magnitude of current flowing through the first load, independent of each of magnitude of voltage at the second load and magnitude of current flowing through the second load.

3. The charging system of claim 1, wherein the controller is further configured to control at least the multi-function DC-to-DC converter to cause the charging system to repeatedly switch between at least the second operating mode and the third operating mode.

4. The charging system of claim 1, wherein the controller is further configured to control at least the multi-function DC-to-DC converter to cause the charging system to repeatedly switch between at least the first operating mode, the second operating mode, and the third operating mode.

5. The charging system of claim 1, wherein:
the multi-function DC-to-DC converter comprises an inductor and a plurality of switching devices electrically coupled to the inductor; and
the controller is configured to control operation of the plurality of switching devices electrically coupled to the inductor to change a topology of the multi-function DC-to-DC converter according to an operating mode of the charging system.

6. The charging system of claim 5, wherein:
energy flows through the inductor in a first direction in the first operating mode; and
energy flows through the inductor in a second direction in each of the second operating mode and the third operating mode, the second direction being opposite of the first direction.

7. The charging system of claim 1, wherein the controller is further configured to control at least the multi-function DC-to-DC converter to enable the charging system to operate in any one of the following additional operating modes:
a fourth operating mode at least partially characterized by the multi-function DC-to-DC converter powering the first load using energy stored in the energy storage device; and
a fifth operating mode at least partially characterized by the multi-function DC-to-DC converter powering the second load using energy stored in the energy storage device.

8. The charging system of claim 7, wherein the controller is further configured to control the multi-function DC-to-DC converter in the fourth operating mode to regulate at least one of magnitude of voltage at the first load and magnitude of current flowing through the first load, independent of each of magnitude of voltage at the second load and magnitude of current flowing through the second load.

9. The charging system of claim 8, wherein the controller is further configured to control the multi-function DC-to-DC converter in the fifth operating mode to regulate at least one of magnitude of the voltage at the second load and magnitude of the current flowing through the second load, independent of each of magnitude of the voltage at the first load and magnitude of the current flowing through the first load.

10. The charging system of claim 7, wherein the controller is further configured to control at least the multi-function DC-to-DC converter to cause the charging system to repeatedly switch between at least the fourth operating mode and the fifth operating mode.

11. The charging system of claim 1, wherein the controller is further configured to control the multi-function DC-to-DC converter in the first operating mode to perform maximum power point tracking (MPPT) with respect to the input power source.

12. The charging system of claim 1, wherein the controller is further configured to control at least the multi-function DC-to-DC converter to enable the charging system to operate in an additional operating mode at least partially characterized by the multi-function DC-to-DC converter powering an additional load using energy stored in the energy storage device, the additional load replacing the input power source.

13. A charging system, comprising:
an inductor electrically coupled between a first switching node and a second switching node;
one or more first power conversion switching devices electrically coupled to the first switching node;
one or more second power conversion switching devices electrically coupled to the second switching node;
a first load switching device electrically coupled between the second switching node and a first output power node;
a second load switching device electrically coupled between the second switching node and a second output power node;
an energy storage device electrically coupled to the first switching node via at least the one or more first power conversion switching devices; and
a controller configured to control at least the one or more first power conversion switching devices, the one or more second power conversion switching devices, the first load switching device, and the second load switching device to enable the charging system to operate in at least any one of the following operating modes:
a first operating mode at least partially characterized by the charging system charging the energy storage device using energy from an input power source,
a second operating mode at least partially characterized by the charging system powering a first load electrically coupled to the first output power node using energy from the input power source, and
a third operating mode at least partially characterized by the charging system powering a second load electrically coupled to the second output power node using energy from the input power source.

14. The charging system of claim 13, wherein:
the first operating mode is further characterized by energy from the input power source flowing through the inductor from the second switching node to the first switching node;
the second operating mode is further characterized by energy from the input power source flowing through the inductor from the first switching node to the second switching node; and
the third operating mode is further characterized by energy from the input power source flowing through the inductor from the first switching node to the second switching node.

15. The charging system of claim 13, wherein the controller is further configured to control at least the one or more first power conversion switching devices and the one or more second power conversion switching devices to regulate at least one of magnitude of voltage at the first load and magnitude of current flowing through the first load, independent of each of magnitude of voltage at the second load and magnitude of current flowing through the second load.

16. The charging system of claim 13, wherein the controller is further configured to control at least the multi-function DC-to-DC converter to cause the charging system to repeatedly switch between at least the second operating mode and the third operating mode.

17. The charging system of claim 13, wherein the controller is further configured to control at least the one or more first power conversion switching devices, the one or more second power conversion switching devices, the first load switching device, and the second load switching device to cause the charging system to repeatedly switch between the first operating mode, the second operating mode, and the third operating mode.

18. The charging system of claim 13, wherein the controller is further configured to control at least the one or more first power conversion switching devices, the one or more second power conversion switching devices, the first load switching device, and the second load switching device to enable the charging system to operate in any one of the following additional operating modes:
a fourth operating mode at least partially characterized by the charging system powering the first load using energy stored in the energy storage device, and
a fifth operating mode at least partially characterized by the charging system powering the second load using energy stored in the energy storage device.

19. A method for operating a charging system, the method comprising:
transferring first energy from an input power source to an energy storage device using a multi-function direct-current-to-direct-current (DC-to-DC) converter by transferring first energy through an inductor of the multi-function DC-to-DC converter in a first direction;
after transferring the first energy from the input power source to the energy storage device, transferring second energy from one of the input power source and the energy storage device to a first load using the multi-function DC-to-DC converter by transferring the second energy through the inductor of the multi-function DC-to-DC converter in a second direction that is opposite of the first direction; and
after transferring the second energy from one of the input power source and the energy storage device to the first load, transferring third energy from one of the input power source and the energy storage device to a second load using the multi-function DC-to-DC converter by transferring the third energy through the inductor of the multi-function DC-to-DC converter in the second direction.

20. The method of claim 19, further comprising controlling the multi-function DC-to-DC converter to regulate a magnitude of a voltage at the first load independently of a magnitude of a voltage at the second load.
